(19) United States
(12) Patent Application Publication
(10) Pub. No.: US 2025/0334977 A1
(43) Pub. Date: Oct. 30, 2025

(54) AERIAL VEHICLE, AND CONTROL METHOD AND APPARATUS OF AERIAL VEHICLE

(71) Applicant: SZ DJI TECHNOLOGY CO., LTD., Shenzhen (CN)

(72) Inventors: Yuman GAO, Shenzhen (CN); Zezao LU, Shenzhen (CN); Zhimeng SHANG, Shenzhen (CN); Yi LIN, Shenzhen (CN)

(21) Appl. No.: 19/263,703

(22) Filed: Jul. 9, 2025

Related U.S. Application Data
(63) Continuation of application No. PCT/CN2023/090223, filed on Apr. 24, 2023.

(51) Int. Cl. G05D 1/654; B64F 1/18; B64U 20/80; G05D 1/622; G05D 1/686; G05D 109/20

(52) U.S. Cl. CPC G05D 1/6542; B64F 1/18; B64U 20/80; G05D 1/622; G05D 1/686; B64U 2201/10; G05D 2109/20

(57) ABSTRACT

An aerial vehicle control method includes controlling an aerial vehicle to follow a movable platform to move based on an image of the movable platform collected by a visual sensor carried by the aerial vehicle, in a process of following the movable platform to move, controlling the aerial vehicle to move to a right side of the movable platform in response to an obstacle existing on a left front side of a moving direction of the movable platform, and in the process of following the movable platform to move, controlling the aerial vehicle to move to a left side of the movable platform in response to an obstacle existing on a right front side of the moving direction of the movable platform.

### CROSS-REFERENCE TO RELATED APPLICATION

The present application is a continuation of International Application No. PCT/CN2023/090223, filed Apr. 24, 2023, the entire content of which is incorporated herein by reference.

### TECHNICAL FIELD

The present disclosure relates to the aerial vehicle technology field and, more particularly, to an aerial vehicle, a control method of the aerial vehicle, and a control apparatus of the aerial vehicle.

### BACKGROUND

In some application scenarios, an aerial vehicle moves with a movable platform. During the following, a visual sensor of the aerial vehicle is configured to collect an image of the movable platform. However, during the following, the visual sensor of the aerial vehicle is blocked by an obstacle to cause the movable platform to be lost.

### SUMMARY

In accordance with the disclosure, there is provided an aerial vehicle control method. The method includes controlling an aerial vehicle to follow a movable platform to move based on an image of the movable platform collected by a visual sensor carried by the aerial vehicle, in a process of following the movable platform to move, controlling the aerial vehicle to move to a right side of the movable platform in response to an obstacle existing on a left front side of a moving direction of the movable platform, and in the process of following the movable platform to move, controlling the aerial vehicle to move to a left side of the movable platform in response to an obstacle existing on a right front side of the moving direction of the movable platform.

In accordance with the disclosure, there is provided an aerial vehicle control apparatus, including one or more processors and one or more memories. The one or more memories store a program that, when executed by the one or more processors, causes the one or more processors to control an aerial vehicle to follow a movable platform to move based on an image of the movable platform collected by a visual sensor carried by the aerial vehicle, in a process of following the movable platform to move, control the aerial vehicle to move to a right side of the movable platform in response to an obstacle existing on a left front side of a moving direction of the movable platform, and in the process of following the movable platform to move, control the aerial vehicle to move to a left side of the movable platform in response to an obstacle existing on a right front side of the moving direction of the movable platform.

### BRIEF DESCRIPTION OF THE DRAWINGS

FIG. 1 is a schematic diagram of an aerial vehicle consistent with the disclosure.

FIG. 2 is a schematic diagram showing an application scenario consistent with the disclosure.

FIG. 3 is a schematic diagram of a movable platform consistent with the disclosure.

FIG. 4 is a schematic flowchart of a control method of an aerial vehicle consistent with the disclosure.

FIG. 5A is a schematic diagram of obstacle distribution consistent with the disclosure.

FIG. 5B is a schematic diagram showing a condition that no obstacle exists in a field of view of a visual sensor consistent with the disclosure.

FIG. 6A is a schematic diagram showing a moving speed of an aerial vehicle without an obstacle consistent with the disclosure.

FIG. 6B is a schematic diagram showing a moving speed of an aerial vehicle with an obstacle consistent with the disclosure.

FIG. 7A is a schematic diagram showing a moving trajectory of an aerial vehicle without an obstacle consistent with the disclosure.

FIG. 7B is a schematic diagram showing a moving trajectory of an aerial vehicle with an obstacle consistent with the disclosure.

FIG. 8 is a schematic diagram showing a change process of a motion state of a movable platform and an aerial vehicle consistent with the disclosure.

FIG. 9 is a schematic flowchart of a control method for an aerial vehicle consistent with the disclosure.

FIG. 10A and FIG. 10B are schematic diagrams showing a follow process of an aerial vehicle with a lane line constraint consistent with the disclosure.

FIG. 11 is a schematic flowchart of another control method for an aerial vehicle consistent with the disclosure.

FIG. 12 is a schematic diagram showing a marking member consistent with the disclosure.

FIG. 13A, FIG. 13B, and FIG. 13C are schematic diagrams showing a process for an aerial vehicle leaving the marking member consistent with the disclosure.

FIG. 14 is a schematic comparison diagram showing images before and after an aerial vehicle leaving the marking member consistent with the disclosure.

FIG. 15 is a schematic comparison diagram showing a force applied to an aerial vehicle consistent with the disclosure.

FIG. 16 is a schematic diagram showing a whole trajectory of an aerial vehicle a during landing process consistent with the disclosure.

FIG. 17 is a schematic diagram showing a moving trajectory of an aerial vehicle when a motion state of a marking member does not satisfy a preset moving condition consistent with the disclosure.

FIG. 18 is a schematic flowchart of another control method for an aerial vehicle consistent with the disclosure.

FIG. 19 is a schematic flowchart of a control process for an aerial vehicle consistent with the disclosure.

### DETAILED DESCRIPTION OF THE EMBODIMENTS

Embodiments of the present disclosure are described in detail in connection with the accompanying drawings of embodiments of the present disclosure. Unless otherwise indicated, the same numbers in different drawings represent the same or similar elements. The embodiments described below do not represent all embodiments of the present disclosure. Instead, the described embodiments are merely examples of apparatuses and methods consistent with some aspects of the present disclosure as detailed in the appended claims.

The term used in the present disclosure is for the purpose of describing particular embodiments only and is not intended to limit the present disclosure. The singular forms “a,” “the,” and “said” used in the specification and the appended claims of the present disclosure are also intended to include the plural forms unless the context clearly indicates otherwise. The term “and/or” used here refers to and includes any or all possible combinations of one or more of the associated listed items.

Although the terms such as first, second, third, etc., can be used in the present disclosure to describe various information. However, the information should not be limited to these terms. These terms are only used to distinguish information of the same type from one another. For example, without departing from the scope of the present disclosure, first information may also be referred to as second information, and similarly, second information may also be referred to as first information. Depending on the context, the word “if” used here may be interpreted as “when,” “while,” or “in response to determining.”

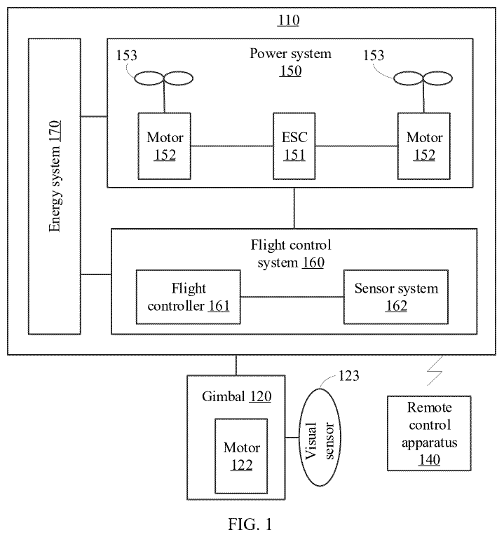

FIG. 1 is a schematic diagram of an aerial vehicle 110 consistent with the disclosure. The aerial vehicle 110 includes a power system 150, a flight control system 160, an energy system 170, a frame, and a gimbal 120 carried by the frame. The aerial vehicle 110 can include various types of unmanned aerial vehicles (UAVs), such as agricultural UAVs or industrial application UAVs, which require cyclic operations.

The frame can include a body and a leg (also referred to as a landing gear). The body can include a central frame and one or more arms connected to the central frame. The one or more arms can extend radially from the central frame. The landing gear can be connected to the body and configured to support the aerial vehicle 110 when the aerial vehicle 110 lands.

The power system 150 can include one or more electronic speed controllers (also simply referred to as “ESCs”) 151, one or more propellers 153, and one or more motors 152 corresponding to the one or more propellers 153. A motor 152 is connected between an ESC 151 and a propeller 153. The motor 152 and the propeller 153 are arranged on an arm of the aerial vehicle 110. The ESC 151 can be configured to receive a drive signal generated by the flight control system 160 and provide a drive current to the motor 152 according to the drive signal to control the rotation speed of the motor 152. The motor 152 can be configured to drive the propeller to rotate to provide power for the flight of the aerial vehicle 110. The power can be used to allow the aerial vehicle 110 to move in one or more degrees of freedom. In some embodiments, the aerial vehicle 110 can rotate around one or more rotation axes. For example, the rotation axes can include a roll axis, a yaw axis, and a pitch axis. The motor 152 can include a DC motor or an AC motor. Additionally, the motor 152 can include a brushless motor or a brushed motor.

The flight control system 160 can include a flight controller 161 and a sensor system 162 of the aerial vehicle 110. The sensor system 162 of the aerial vehicle 110 can be configured to collect sensor data of the aerial vehicle 110. The sensor data can include but is not limited to spatial position information and status information of the aerial vehicle 110, such as a three-dimensional position, a three-dimensional angle, a three-dimensional velocity, a three-dimensional acceleration, and a three-dimensional angular velocity. The sensor system 162 of the aerial vehicle 110 can include, for example, at least one of a gyroscope, an ultrasonic sensor, an electronic compass, an inertial measurement unit (IMU), a visual sensor, a global navigation satellite system, and a barometer. For example, the global navigation satellite system can be the Global Positioning System (GPS). The flight controller 161 can be configured to control the motion state of the aerial vehicle 110. For example, the motion state of the aerial vehicle 110 can be controlled according to attitude information measured by the sensor system 162 of the aerial vehicle 110. The flight controller 161 can be configured to control the aerial vehicle 110 according to pre-programmed program instructions or by responding to one or more remote control signals from a remote control apparatus 140.

The gimbal 120 can include a motor 122. The gimbal can be configured to carry a visual sensor 123. The flight controller 161 can be configured to control the movement of the gimbal 120 through the motor 122. In some other embodiments, the gimbal 120 can also include a controller configured to control the movement of the gimbal 120 by controlling the motor 122. The gimbal 120 can be independent of the aerial vehicle 110 or can be a part of the aerial vehicle 110. The motor 122 can include a DC motor or an AC motor. Additionally, the motor 122 can include a brushless motor or a brushed motor.

The visual sensor 123, for example, can be a device such as a camera or recorder configured to capture images. The visual sensor 123 can communicate with the flight controller 161 and perform shooting under the control of the flight controller 161. One or more visual sensors 123 can be provided. Different visual sensors 123 can have different orientations. For example, at least one visual sensor 123 can face a side of the aerial vehicle 110 (including the front, left, right, and/or rear sides). At least one visual sensor 123 of the other visual sensors 123 can face the underside of the aerial vehicle 110. The visual sensor 123 of embodiments of the present disclosure can at least include a photosensitive element. The photosensitive element can include, e.g., a Complementary Metal Oxide Semiconductor (CMOS) sensor or a Charge-Coupled Device (CCD) sensor. The visual sensor 123 can also be directly fixed to the aerial vehicle 110. Thus, the gimbal 120 can be omitted.

The energy system 170 can include one or more batteries and a Battery Management System (BMS). The batteries can be used to supply power to the power system 150, the flight control system 160, the gimbal 120, and the load on the gimbal 120 (e.g., the visual sensor 123). The BMS can be used to manage and control the charging and discharging processes of the batteries.

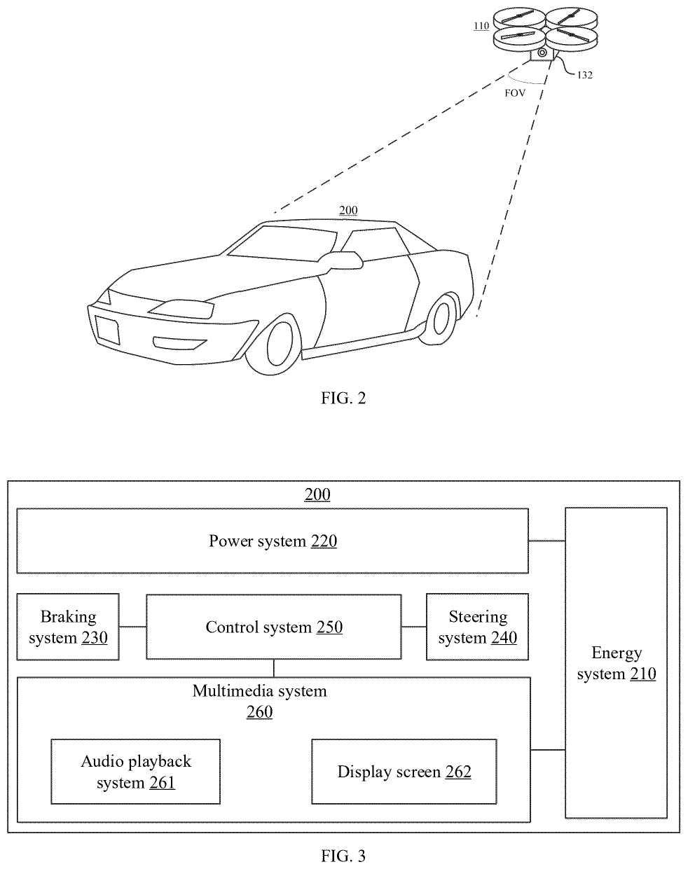

FIG. 2 is a schematic diagram showing an application scenario consistent with the disclosure. The aerial vehicle 110 can take off from a movable platform 200 and follow the movable platform 200 to move in a space. The aerial vehicle 110 can also capture an image of the movable platform 200 using the visual sensor 123 of the aerial vehicle 110 to complete tasks, such as aerial photography. The area within the two dashed lines in the figure represents the Field of View (FOV) of the visual sensor 123, i.e., the vision range. The movable platform 200 can be a land-based movable platform or a water-based movable platform. The land-based movable platform can include various land vehicles such as cars, buses, and trucks, or various mobile robots, such as cleaning robots. The water-based movable platform can include various watercraft such as commercial ships, passenger ships, yachts, fishing boats, sailboats, and civilian boats, or water inspection devices, water treatment devices, and water environment monitoring devices capable of moving on water. In some embodiments, the movable platform 200 can include autonomous movement capabilities in one or two dimensions and can perform passive movement in other dimensions. For example, when the movable platform 200 is a land-based movable platform, the land-based movable platform can have autonomous movement capabilities in the horizontal direction (e.g., moving, reversing, or turning). The land-based movable platform can perform passive movement in the vertical direction (uphill or downhill) under the influence of the slope of the road where the land-based movable platform is on. In an embodiment, the maximum moving speed of the movable platform 200 can be greater than or equal to 30 km/h.

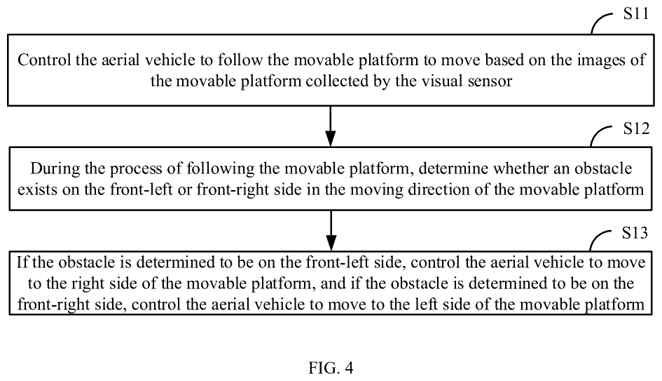

FIG. 3 is a schematic diagram of a movable platform 200 consistent with the disclosure. The movable platform 200 includes an energy system 210, a power system 220, a braking system 230, a steering system 240, and a control system 250. The energy system 210 can be configured to provide energy to the power system 220 and the control system 250. The power system 220 can be configured to convert the energy provided by the energy system 210 into mechanical energy and output power for the movable platform 200. The braking system 230 can be configured to reduce the moving speed of the movable platform 200. The steering system 240 can be configured to control the steering of the movable platform 200. The braking system 230 and the steering system 240 can realize corresponding functions under the control of the driver of the movable platform 200 or the control system 250. In some embodiments, the control system 250 can perform path planning for the movable platform 200 and control the movable platform 200 to move automatically along the planned path. Furthermore, the control system 250 can also obtain the motion state (e.g., speed, position) of the movable platform 200 and communicate with the aerial vehicle 110 to send the motion state of the movable platform 200 to the aerial vehicle 110.

In some embodiments, the movable platform 200 can also include a multimedia system 260 configured to provide multimedia services to passengers taking the movable platform 200. The electrical energy required for the operation of the multimedia system 260 can be provided by the energy system 210. The multimedia system 260 can include an audio playback system 261 and a display screen 262. The audio playback system 261 can be configured to play audio files and audio prompt information generated during the movement of the movable platform 200 to prompt the information related to the motion state of the movable platform 200. The display screen 262 can display the planned path of the movable platform 200, visual prompt information generated during the movement of the movable platform 200, and/or video files selected by a passenger for playback. The multimedia system 260 can provide multimedia services under the control of the driver of the movable platform 200 or the control system 250.

In the follow scenario shown in FIG. 2, the aerial vehicle 110 captures the images of the movable platform 200 using the visual sensor 123 carried by the aerial vehicle 110. The aerial vehicle 110 can follow the movable platform 200 to move in the space based on the images of the movable platform 200. In some embodiments, the movable platform 200 can also report the motion state of the movable platform 200 to the aerial vehicle 110 to allow the aerial vehicle to follow the movable platform 200 to move in the space based on the motion state reported by the movable platform 200 or based on the motion state reported by the movable platform 200 and the images captured by the visual sensor 123. During the follow process, the motion state of the movable platform 200 can change, and the movable platform 200 may be blocked by an obstacle in the space to cause the movable platform 200 to be lost in the field of view of the visual sensor 123, which leads to a follow failure. Thus, the control method of the aerial vehicle 110 may need to be improved to increase the success rate in following the movable platform 200.

FIG. 4 is a schematic flowchart of a control method of the aerial vehicle 110 consistent with the disclosure. The aerial vehicle 110 carries the visual sensor 123 configured to collect the images. The method includes the follow processes.

At S11, the aerial vehicle 110 is controlled to follow the movable platform 200 to move based on the images of the movable platform 200 collected by the visual sensor 123.

At S12, during the process of following the movable platform 200, whether an obstacle exists on the front-left or front-right side in the moving direction of the movable platform 200 is determined.

At S13, if the obstacle is determined to be on the front-left side, the aerial vehicle 110 is controlled to move to the right side of the movable platform 200; if the obstacle is determined to be on the front-right side, the aerial vehicle 110 is controlled to move to the left side of the movable platform 200.

In embodiments of the present disclosure, the orientation of the aerial vehicle 110 following the movable platform 200 can be adjusted based on the position of the obstacle in space and the moving direction of the movable platform 200 to cause the aerial vehicle 110 to move toward the side away from the obstacle in the moving direction the movable platform 200. Thus, the aerial vehicle 110 can actively avoid the blocking of the movable platform 200 by the obstacle to make the image of the movable platform 200 captured by the visual sensor 123 consistent. Therefore, more perceptual information about the movable platform 200 can be obtained, which reduces the loss rate of the movable platform 200 during the follow process and improves the success rate of following.

In some embodiments, the method can further include determining the turning direction of the movable platform 200, and determining whether an obstacle on the front-left or front-right side in the moving direction of the movable platform 200 is located on the inner side of the turning direction.

In some embodiments, if an obstacle is determined to be on the front-left side in the moving direction of the movable platform 200, the aerial vehicle 110 can be controlled to move to the right side of the movable platform 200. If an obstacle is determined on the front-right side in the moving direction of the movable platform 200, the aerial vehicle 110 can be controlled to move to the left side of the movable platform 200. This process can include if an obstacle is determined to be on the front-left side and located on the inner side of the turning direction, controlling the aerial vehicle 110 to move to the right side of the movable platform 200, and if an obstacle is determined to be on the front-right side and located on the inner side of the turning direction, controlling the aerial vehicle 110 to move to the left side of the movable platform 200.

In some embodiments, during the process of following the movable platform 200, if no obstacle exists, the aerial vehicle 110 can maintain following at the rear side of the movable platform 200.

The method of embodiments of the present disclosure can be executed by the flight controller 161 of the aerial vehicle 110.

At S11, the flight controller 161 can be configured to obtain the images captured by the visual sensor 123, determine the motion state of the movable platform 200 based on the images, and control the aerial vehicle 110 to follow the movable platform 200 based on the motion state. The motion state can include a real-time motion state of the movable platform 200 or a motion state of the movable platform 200 during a historical time period (e.g., the last 2 seconds, the last 3 seconds, etc.). In some embodiments, the motion state of the movable platform 200 can include the moving direction, moving speed, attitude, and/or position of the movable platform 200. Furthermore, the flight controller 161 can also communicate with the movable platform 200 to obtain the motion state reported by the movable platform 200 and control the aerial vehicle 110 to follow the movable platform 200 in combination with the motion state reported by the movable platform 200 and the motion state determined based on the images.

During the follow process, the flight controller 161 can plan the moving trajectory of the aerial vehicle 110 for a future time period (e.g., the next 3 seconds or the next 5 seconds). For example, the flight controller 161 can predict the moving trajectory of the movable platform 200 for the future time period based on the obtained motion state of the movable platform 200 and plan the moving trajectory of the aerial vehicle 110 for the future time period based on the predicted moving trajectory. Alternatively, the flight controller 161 can be configured to directly plan the moving trajectory of the aerial vehicle 110 for the future time period based on the obtained motion state of the movable platform 200. Meanwhile, the flight controller 161 can update the planned moving trajectory for the aerial vehicle 110 at a preset update time interval. The time length corresponding to the update time interval can be less than the time length corresponding to the future time period. In some embodiments, the flight controller 161 can send the planned moving trajectory for the aerial vehicle 110 to the remote control apparatus 140 and/or the display screen 262 of the movable platform 200 to display the planned moving trajectory on the display interface of the remote control apparatus 140 and/or the display screen 262. Thus, the user can intuitively observe the planned moving trajectory for the aerial vehicle 110.

During the follow process, the flight controller 161 can also be configured to control the moving speed of the aerial vehicle 110 so that the relative speed between the aerial vehicle 110 and the movable platform 200 satisfies a certain speed condition. The speed condition can include that the relative speed between the aerial vehicle 110 and the movable platform 200 is zero, or the relative speed between the speed component of the aerial vehicle 110 in the moving direction of the movable platform 200 and the moving speed of the movable platform 200 is zero. Thus, the aerial vehicle 110 can follow the movable platform 200 more stably. In some embodiments, the speed condition can also include that the moving speed of the aerial vehicle 110 is less than the moving speed of the movable platform 200 to increase the distance between the aerial vehicle 110 and the movable platform 200. In other embodiments, the speed condition can also include that the moving speed of the aerial vehicle 110 is greater than the moving speed of the movable platform 200 to decrease the distance between the aerial vehicle 110 and the movable platform 200. According to the actual situation, other speed conditions can also be set, which are not listed here.

During the follow process, the flight controller 161 can also be configured to control the orientation of the visual sensor 123 so that the visual sensor 123 always faces the movable platform 200 during the follow process. The orientation of the visual sensor 123 can be controlled by controlling the attitude of the aerial vehicle 110. In some embodiments, the visual sensor 123 is arranged at the gimbal 120, the orientation of the visual sensor 123 can be controlled by controlling the attitude of the gimbal 120. When the aerial vehicle 110 carries a plurality of visual sensors 123 with different orientations, the orientation of the visual sensor 123 can be controlled by switching between the different visual sensors 123.

During the follow process, the flight controller 161 can also be configured to control the power system 150 of the aerial vehicle 110 to increase or decrease the power output by the power system 150.

Through at least one of the control actions of the flight controller 161, the aerial vehicle 110 can maintain a motion state that is nearly synchronized with the movable platform 200 at a certain degree (e.g., on certain trajectory segments). That is, the aerial vehicle 110 can follow the movable platform 200 to move and cause the visual sensor 123 to continuously observe of the movable platform 200 as much as possible.

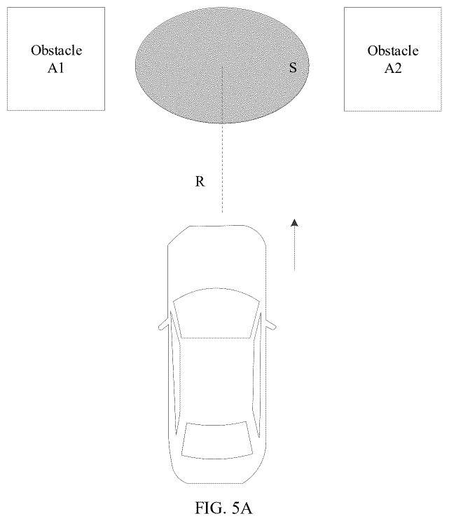

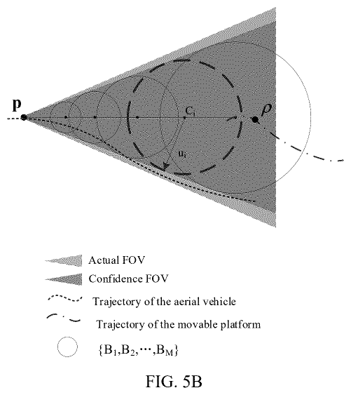

At S12, during the process of the aerial vehicle 110 following the movable platform 200, the flight controller 161 can be configured to determine whether an obstacle is on the front-left or front-right side in the moving direction of the movable platform 200. The obstacle can refer to an object that affects the moving trajectory of the movable platform 200, which can include but is not limited to dynamic objects such as people, animals, or other movable platforms in the space where the movable platform 200 is located, or static objects such as guardrails, walls, railings, and roadblocks. FIG. 5A illustrates a schematic diagram showing obstacle A1 on the front-left side in the moving direction of the movable platform 200 and obstacle A2 on the front-right side in the moving direction of the movable platform 200.

The sensor system 162 of the movable platform 200 can be configured to sense the space where the movable platform 200 is located to determine whether an obstacle exists on the front-left or front-right side in the moving direction of the movable platform 200. The sensor system 162 can include the visual sensor 123 or other visual sensors, or sensing apparatuses with environmental perception capabilities such as LiDAR, ultrasonic radar, or millimeter-wave radar. Alternatively, the flight controller 161 can be also configured to obtain prior information about the positional distribution of the objects in the space where the movable platform 200 is located and determine whether an obstacle exists on the front-left or front-right side in the moving direction of the movable platform 200 based on the prior information and the position of the movable platform 200. In connection with FIG. 5A, the solution of the present disclosure is described be taking determining whether obstacle A1 exists on the front-left side in the moving direction of the movable platform 200 as an example.

As shown in FIG. 5A, obstacle A1 is located on the front-left side in the moving direction of the movable platform 200 (as indicated by the arrow in the figure), i.e., the left front side of the movable platform 200 that is the left side of target driving area S of the movable platform 200 (the gray elliptical area in the figure) or the left side of the area pointed to by the moving direction of the movable platform 200. The flight controller 161 can be configured to determine whether an obstacle will appear on the left side of the movable platform 200 within a future time period. If so, obstacle A1 can be determined to be on the front-left side in the moving direction of the movable platform 200. In some embodiments, the flight controller 161 can be configured to predict moving trajectory R of the movable platform 200 within a future time period based on the images captured by the visual sensor 123. If an obstacle exists on the left side of predicted moving trajectory R, the obstacle can be indicated to appear on the left side of the movable platform 200 within the future time period. That is, obstacle A1 may exist on the front-left side in the moving direction of the movable platform 200. Alternatively, the flight controller 161 can also be configured to obtain the path planned by the control system 250 for the movable platform 200 in the future time period. If an obstacle is on the left side of the planned path, the obstacle can be indicated to appear on the left side of the movable platform 200 within the future time period. That is, obstacle A1 may exist on the front-left side in the moving direction of the movable platform 200.

When the obstacle and the movable platform 200 are in a motion state, when determining whether obstacle A1 is on the front-left side in the moving direction of the movable platform 200, the motion state of the movable platform 200 and the motion state of obstacle A1 may need to considered at the same time. If the obstacle is stationary while the movable platform 200 is in motion, only the motion state of the movable platform 200 may need to be considered when determining whether obstacle A1 is on the front-left side in the moving direction of the movable platform 200.

The method for determining whether obstacle A2 is on the front-right side in the moving direction of the movable platform 200 can be similar to the method for determining whether obstacle A1 is on the front-left side, which is thus not repeated here.

At S13, to ensure continuous observation of the movable platform 200, no obstacle is desired within the field of view of the visual sensor 123. Therefore, the moving trajectory of the aerial vehicle 110 can be adjusted to actively cause the aerial vehicle 110 to move in a direction with the least blocking.

As shown in FIG. 5B, the light gray triangle area represents the field of view (FOV) of the visual sensor 123 of the aerial vehicle 110. The dark gray triangle area represents the confidence FOV where the movable platform 200 is expected to not be blocked by an obstacle in the confidence FOV. A series of spherical areas {B1, B2, . . . , BM} can be used to approximate the confidence FOV. One spherical region Bi of the series of spherical areas is shown as the circular area enclosed by the dashed line in the figure, with a center at Cᵢ and a radius uᵢ expressed as:

$${C}_{i} = p + {λ}_{i} ( ρ - p ) ; \\ {u}_{i} = ρ \cdot {λ}_{i} \cdot ‖ p - ρ ‖ ;$$

where p denotes the position of the aerial vehicle 110, ρ denotes the position of the movable platform 200, and

$${λ}_{i} = \frac{i}{M} ∈ [ 0 , 1 ]$$

is a constant determined by the shape of the confidence FOV.

The constraint condition for ensuring no blocking by an obstacle within the confidence FOV includes that, for each spherical area Bi in {B1, B2, . . . , BM}:

$${u}_{i} < Ξ ( {C}_{i} )$$

wherein Ξ(Cᵢ) denotes the Euclidean Signed Distance Field (ESDF) value at Cᵢ. As long as the distance to the nearest obstacle at point Cᵢ is greater than the radius uᵢ of spherical area Bᵢ, no obstacle can be ensured within spherical area Bᵢ.

To satisfy the above condition as much as possible, the flight controller 161 can be configured to control the aerial vehicle 110 to move toward the side away from the obstacle in the moving direction of the movable platform 200. In some embodiments, if obstacle A1 exists on the front-left side in the moving direction of the movable platform 200, the flight controller 161 can control the aerial vehicle 110 to move toward the right side of the movable platform 200. If obstacle A2 exists on the front-right side in the moving direction of the movable platform 200, the flight controller 161 can control the aerial vehicle 110 to move toward the left side of the movable platform 200.

The aerial vehicle 110 moving toward the side away from the obstacle can indicate that the moving speed of the aerial vehicle 110 has a speed component toward the side away from the obstacle. In addition to the speed component in the direction, the aerial vehicle 110 can include speed components in other directions (e.g., the moving direction of the movable platform 200). For example, if obstacle A1 exists on the front-left side in the moving direction of the movable platform 200, during the process the flight controller 161 controlling the aerial vehicle 110 to move toward the right side of the movable platform 200, the aerial vehicle 110 can have a speed component toward the right side of the movable platform 200 and a speed component in the moving direction of the movable platform 200. Thus, due to the speed components in both directions, the aerial vehicle 110 can both move away from the obstacle and maintain a certain relative speed in the moving direction of the movable platform 200 to ensure that the aerial vehicle 110 can follow the movable platform 200 to move. In other embodiments, the flight controller 161 can also control the aerial vehicle 110 to first adjust the current moving direction to the direction away from the obstacle and, after moving away from the obstacle, adjust the moving direction to align with the moving direction of the movable platform 200, and increase the speed of the aerial vehicle 110 to catch up with the movable platform 200.

In some embodiments, when the aerial vehicle 110 begins to move in the direction away from the obstacle, the obstacle can be still on the front-left or front-right side in the moving direction of the movable platform 200. That is, the movable platform 200 is usually not yet blocked by the obstacle. That is, the flight controller 161 can proactively controls the aerial vehicle 110 to move in the direction opposite to the obstacle when a possibility exists that the movable platform 200 may be blocked by the obstacle to reduce the possibility of losing the movable platform 200 from the field of view of the visual sensor 123 of the aerial vehicle 110.

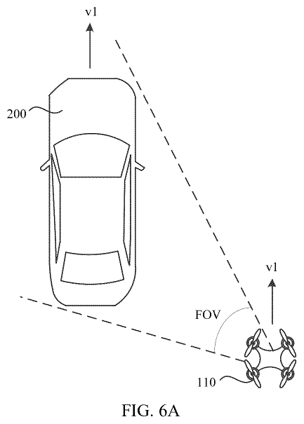

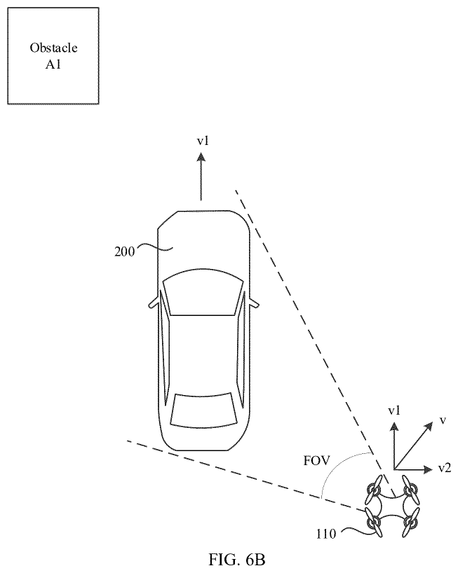

In some embodiments, as shown in FIG. 6A, the movable platform 200 moves at speed v1, and the aerial vehicle 110 follows the movable platform 200 at same speed v1 from the rear-right side of the movable platform 200. The visual sensor 123 on the aerial vehicle 110 captures the images of the movable platform 200 from the rear-right side of the movable platform 200. As shown in FIG. 6B, when obstacle A1 is determined to be on the front-left side of the movable platform 200, the moving speed of the aerial vehicle 110 is adjusted to v. Speed v includes a speed component v1 in the moving direction of the movable platform 200 and a speed component v2 toward the right side of the movable platform 200.

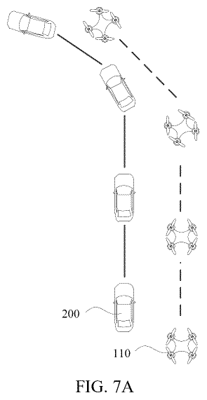

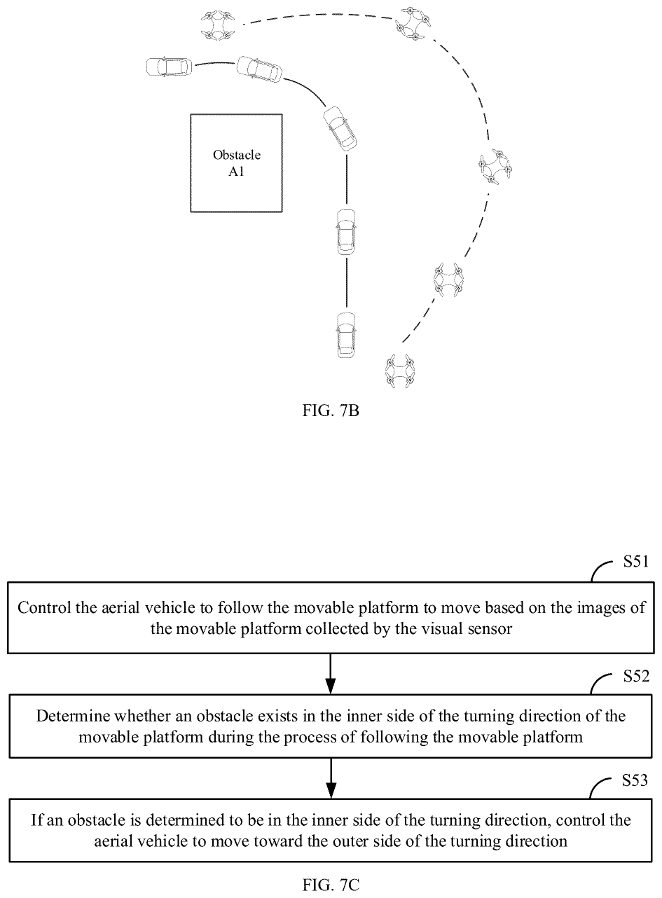

In some embodiments, as shown in FIG. 7C, a control method for the aerial vehicle 110 is provided. The aerial vehicle 110 carries a visual sensor 123 configured to capture images. The method includes controlling the aerial vehicle 110 to follow the movable platform 200 to move based on the images of the movable platform 200 collected by the visual sensor 123 (S51), determining whether an obstacle exists in the inner side of the turning direction of the movable platform 200 during the process of following the movable platform 200 (S52), and if an obstacle is determined to be in the inner side of the turning direction, controlling the aerial vehicle 110 to move toward the outer side of the turning direction (S53).

In some embodiments, the motion information of the movable platform 200 can be obtained, and the turning direction of the movable platform 200 can be predicted based on the motion information. For example, the change amount in the moving direction can be calculated by continuously observing the moving direction of the movable platform 200 to determine the turning direction of the movable platform 200. Alternatively, the turning direction of the movable platform 200 can be determined by calculating the change amount in the lateral moving speed or the acceleration of the lateral movement of the movable platform 200. For example, the lateral movement can include the movement toward the left or right side of the body of the movable platform 200, and the longitudinal movement can be the movement toward the front or rear side of the body of the movable platform 200. In some embodiments, the planned trajectory information of the movable platform 200 can also be obtained, and the turning direction can be determined according to the positions of the waypoints in the trajectory.

In some embodiments, the shape of the forward passable channel of the movable platform 200 can be obtained to determine the turning direction of the movable platform. The aerial vehicle 110 can determine the shape of the passable channel by observing the surrounding environmental information of the movable platform 200. For example, if the movable platform 200 is a vehicle, the movement of the vehicle in the space can be constrained by a feasible road. The passable channel can be a road-constrained channel. If the movable platform 200 is a ship, the movement of the ship in the space can be constrained by a navigable waterway, and the passable channel can be a waterway-constrained channel. If the movable platform 110 is an aerial vehicle, the movement of the aerial vehicle 110 in the space can be constrained by the distribution of the obstacles in the space, and the passable channel can be a flight path-constrained channel.

The inner side of the turning direction can be the side where the center of curvature of the turning trajectory is located. For example, if the movable platform 200 turns left, the inner side of the turning direction can be the left side of the body. If the movable platform 200 turns right, the inner side of the turning direction can be the right side of the body.

In some embodiments, if an obstacle is determined to be on the inner side of the turning direction, the aerial vehicle 110 can be controlled to move toward the outer side of the turning direction before the movable platform 200 begins to turn. In some embodiments, if an obstacle is determined to be on the inner side of the turning direction, the aerial vehicle 110 can be controlled to move toward the outer side of the turning direction before the movable platform 200 enters the turning channel. In some embodiments, if an obstacle is determined to be on the inner side of the turning direction, the aerial vehicle 110 can be controlled to move toward the outer side of the turning direction before the movable platform 200 enters the turning channel.

FIGS. 7A and 7B illustrate schematic diagrams of the trajectories of the aerial vehicle 110 without and with obstacle A1, respectively. The solid line represents the moving trajectory of the movable platform 200, and the dashed line represents the moving trajectory of the aerial vehicle 110. The movable platform 200 and the aerial vehicle 110 move from bottom to top. In the scenario shown in FIG. 7A, the aerial vehicle 110 follows the movable platform 200 to turn left, and no obstacle exists on the front-left side of the movable platform 200. Then, the moving trajectory of the aerial vehicle 110 is nearly consistent with the moving trajectory of the movable platform 200. In the scenario shown in FIG. 7B, the aerial vehicle 110 follows the movable platform 200 to turn left, and an obstacle is on the front-left side of the movable platform 200. The obstacle is located on the inner side of the turning direction of the movable platform 200. Before the movable platform 200 begins to bypass obstacle A1, the aerial vehicle 110 moves toward the right side of the movable platform 200 in advance, that is, the aerial vehicle 110 moves toward the outer side of the turning direction of the movable platform 200, to reduce the possibility of the visual sensor 123 being blocked by obstacle A1.

The above application scenarios are merely illustrative and are not intended to limit the present disclosure. In other application scenarios, during at least some moments when the aerial vehicle 110 follows the movable platform 200, the moving speed of the aerial vehicle 110 can be different from the moving speed of the movable platform 200. For example, the aerial vehicle 110 can periodically accelerate and decelerate to maintain the distance from the movable platform 200 to be in a certain range. For another example, the application scenario where the aerial vehicle 110 moves away from an obstacle is not limited to the scenario where the movable platform 200 bypasses the obstacle. The application scenario can also include an scenario where the obstacle moves to one side of the movable platform 200 or other scenarios where the flight controller 161 determines that an obstacle is on one side of the movable platform 200.

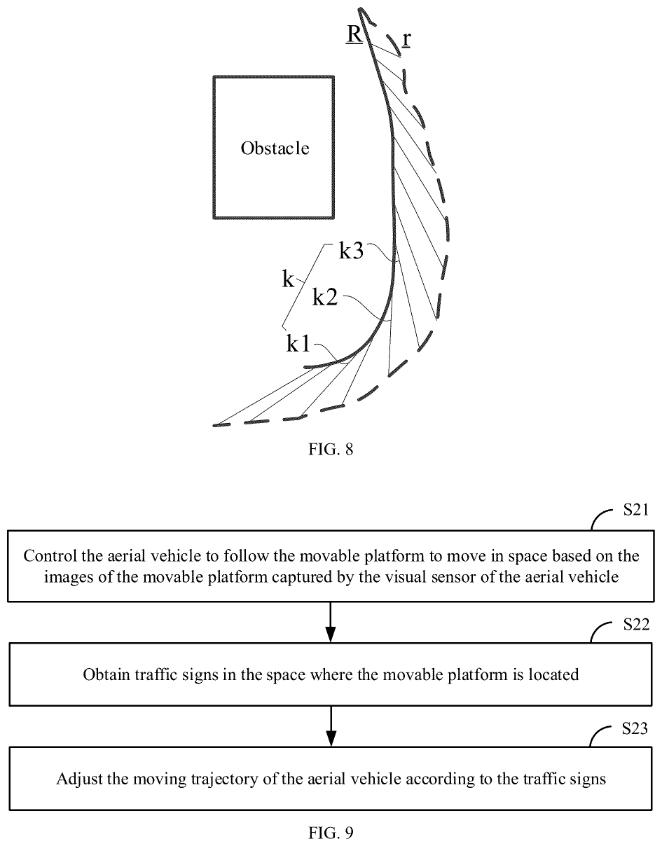

FIG. 8 is a schematic diagram showing a change process of the motion state of the movable platform 200, the motion state of the aerial vehicle 110, and the orientation of the visual sensor 123 of the aerial vehicle 110 consistent with the disclosure. Bold solid line R represents the moving trajectory of the movable platform 200. A tangent direction of the moving trajectory R of the movable platform can be the moving direction of the movable platform 200. Bold dashed line r represents the moving trajectory of the aerial vehicle 110. The tangent direction of the moving trajectory r of the aerial vehicle 110 can be the moving direction of the aerial vehicle 110. The direction of the connection line k between the moving trajectory R of the moving platform 200 and the moving trajectory r of the aerial vehicle 110. The intersection points between any one connection line k and the two moving trajectories represent the positions of the movable platform 200 and the aerial vehicle 110 simultaneously.

In some embodiments, during the process of controlling the aerial vehicle 110 to move toward the right or left side of the movable platform 200, the angle between the orientation of the visual sensor 123 of the aerial vehicle 110 and the moving direction of the movable platform 200 may gradually increase. For example, the directions of connection lines k1, k2, and k3 in FIG. 8 indicate the orientations of the visual sensor 123 and the moving directions of the movable platform 200 at different moments, respectively. The three moving directions of the movable platform 200 at different moments correspond to the tangent direction at the intersection point between the moving trajectory R and the connection line k1, the tangent direction at the intersection point between the moving trajectory R and the connection line k2, and the tangent direction at the intersection point between the moving trajectory R and the connection line k3. During the process of the aerial vehicle 110 following the movable platform 200 to move from bottom to top, the angle between the direction of connection line k1 and the tangent direction of the moving trajectory R at the intersection point with connection line k1 is the smallest, the angle between the direction of connection line k2 and the tangent direction of the moving trajectory R at the intersection point with connection line k2 is intermediate, and the angle between the direction of connection line k3 and the tangent direction of the moving trajectory R at the intersection point with connection line k3 is the largest.

Furthermore, the angle between the orientation of the visual sensor 123 and the moving direction of the movable platform 200 can gradually increase within a first preset angle range. In some embodiments, the first preset angle range can be related to the relative orientation between the aerial vehicle 110 and the movable platform 200. For example, assume that the aerial vehicle 110 needs to follow the movable platform 200 from the rear-right side or directly above, the first preset angle range can be [0, 90°]. In other embodiments, another first preset angle range can also be set according to actual needs.

In some embodiments, during certain moments in the process of controlling the aerial vehicle 110 to move toward the right or left side of the movable platform 200, the distance between the movable platform 200 and the obstacle can be less than the distance between the aerial vehicle 110 and the obstacle at the same moment. Since the aerial vehicle 110 needs to move toward the side away from the obstacle, compared to the distance between the movable platform 200 and the obstacle, the distance between the aerial vehicle 110 and the obstacle can include a distance component in the direction away from the obstacle to cause the distance between the aerial vehicle 110 and the obstacle greater.

In some embodiments, during certain moments in the process of controlling the aerial vehicle 110 to move toward the right or left side of the movable platform 200, the distance component of the distance between the aerial vehicle 110 and the obstacle in the direction perpendicular to the moving direction of the movable platform 200 can gradually increase. For example, assume that the obstacle is located on the front-left side of the movable platform 200, and the movable platform 200 is moving due north, during certain moments in the process of controlling the aerial vehicle 110 to move toward the right or left side of the movable platform 200, the distance component of the distance between the aerial vehicle 110 and the obstacle in the due east direction can a gradually increase.

In some embodiments, in the process of controlling the aerial vehicle 110 to move toward the right or left side of the movable platform 200, the orientation of the visual sensor 123 can be inconsistent with the moving direction of the aerial vehicle 110. That is, because the visual sensor 123 needs to face the direction of the movable platform 200 to continuously capture the images of the movable platform 200. However, the moving direction of the aerial vehicle 110 needs to include a movement component toward the side away from the obstacle to reduce the blocking of the visual sensor 123 by the obstacle.

In some embodiments, during certain moments in the process of controlling the aerial vehicle 110 to move toward the right or left side of the movable platform 200, the moving speed of the aerial vehicle 110 can be greater than the moving speed of the movable platform 200. For example, in the scenario shown in FIG. 6B, the aerial vehicle 110 needs to maintain the same moving speed v1 as the movable platform 200 in the moving direction of the movable platform 200 to follow the movable platform 200 to move. Meanwhile, the aerial vehicle 110 needs to move toward the right side of the moving direction of the movable platform 200 at a certain speed v2 to move away from the obstacle. Thus, the total moving speed v of the aerial vehicle 110 is greater than v1.

In some embodiments, during certain moments in the process of controlling the aerial vehicle 110 to move toward the right or left side of the movable platform 200, the speed component of the moving speed of the aerial vehicle 110 in the moving direction of the movable platform 200 can be greater than the moving speed of the movable platform 200 in moving direction. In one application scenario, in the process of the aerial vehicle 110 following the movable platform 200, the aerial vehicle 110 can move from the rear of the movable platform 200 to the side or front of the movable platform 200. Thus, the speed component of the moving speed of the aerial vehicle 110 in the moving direction of the movable platform 200 may need to be greater than the moving speed of the movable platform 200 in at least certain moments. Thus, the aerial vehicle 110 can catch up to or surpass the movable platform 200 in the moving direction of the movable platform 200.

In some embodiments, during the process of controlling the aerial vehicle 110 to move toward the right or left side of the movable platform 200, the distance between the aerial vehicle 110 and the movable platform 200 can be maintained within a preset distance range. Thus, high visibility of the movable platform 200 can be maintained to improve the accuracy of following control. In some embodiments, the preset distance range can be set as a fixed range. Alternatively, the preset distance range can be dynamically set based on factors such as weather, image acquisition parameters of the visual sensor 123 of the aerial vehicle 110, and/or the moving speed of the movable platform 200. The distance between the aerial vehicle 110 and the movable platform 200 can be determined based on the position of the aerial vehicle 110 and the position of the movable platform 200. The position of the aerial vehicle 110 can be obtained through a positioning module of the aerial vehicle 110 (e.g., GPS, IMU, etc.) or through a visual positioning method. The position of the movable platform 200 can be obtained from the images captured by the visual sensor 123. The movable platform 200 can also include a positioning module and can send position information reported by the positioning module to the aerial vehicle 110. Thus, the aerial vehicle 110 can perform fusion on the position information of the movable platform 200 obtained from the image and the position information reported by the movable platform 200 to obtain more accurate position information of the movable platform 200.

In some embodiments, in the process of controlling the aerial vehicle 110 to move toward the right or left side of the movable platform 200, the angle between the direction of the optical axis of the visual sensor 123 and the direction of the connection line between the movable platform 200 and the aerial vehicle 110 can be within a second preset angle range. Thus, the visual sensor 123 can directly face the movable platform 200 as much as possible to better observe the movable platform 200. When the visual sensor 123 is mounted on a gimbal 120, the yaw angle of the gimbal can be adjusted to cause the optical axis of the visual sensor 123 to satisfy the above condition. When the visual sensor 123 is fixedly mounted on the aerial vehicle 110, the yaw angle of the aerial vehicle 110 can also be adjusted to cause the optical axis of the visual sensor 123 to satisfy the above condition. Taking the situation where the visual sensor 123 is fixedly mounted on the aerial vehicle 110 as an example, assume that the visual sensor 123 is fixedly mounted on the front of the aerial vehicle 110, the desired yaw angle ψ of the aerial vehicle 110 is:

$$ψ = atan 2 ( {e}_{y}^{T} ( ρ - p ) , {e}_{x}^{T} ( ρ - p ) )$$

where, eₓ=[1, 0, 0]^{T}, e_{y}=[0, 1, 0]^{T}, p denotes the position of the aerial vehicle 110, and ρ denotes the position of the movable platform 200.

As shown in FIG. 9, embodiments of the present disclosure also provide a control method for the aerial vehicle 110. The method includes controlling the aerial vehicle 110 to follow the movable platform 200 to move in space based on the images of the movable platform 200 captured by the visual sensor 123 of the aerial vehicle 110 (S21), obtaining traffic signs in the space where the movable platform 200 is located (S22), and adjusting the moving trajectory of the aerial vehicle 110 according to the traffic signs (S23).

For details of process S21, reference can be made to process S11 above, which is not repeated here.

At S22, the traffic signs can be planar traffic signs within the moving plane of the movable platform 200 or three-dimensional traffic signs in the space. For example, when the movable platform 200 is a land-based movable platform, the traffic signs can include but are not limited to at least one of lane lines, turning indicator lines, traffic signs, traffic lights, road barriers, or rows of streetlights, trees, utility poles, or roadblocks. When the movable platform 200 is a water-based movable platform, the traffic signs can include navigation markers such as lighthouses or the boundaries of riverbanks on both sides of the waterway. The visual sensor 123 or other visual sensors of the aerial vehicle 110 can be configured to capture the images of the movable platform 200 in the space. The traffic signs in the space of the movable platform 200 can be determined by analyzing the images or prior information. For example, the map of the space of the movable platform 200 can be pre-stored. Traffic signs such as lane lines, traffic identifiers, and traffic lights can be obtained from the map based on the position of the movable platform 200.

The traffic signs in the space of the movable platform 200 can be used to instruct the movable platform 200 to move within a constrained area. For example, the traffic sign can be a lane line. The constrained area can be the lane. The lane can be the area on one side of the lane line or the area between two neighboring lane lines. When the movable platform 200 moves according to the instruction of the lane line, the moving trajectory of the movable platform 200 can be within the lane constrained by the lane lines. In the example that the traffic sign is a turning indicator line, the constrained area can be the curved lane indicated by the turning indicator line. When the movable platform 200 moves according to the instruction of the turning indicator line, the moving trajectory of the movable platform 200 can be within the curved lane instructed by the turning indicator line. The above is only exemplary and not intended to limit the present disclosure. For example, in extreme weather, a planar traffic sign may be covered by rain or snow, and the constrained area can be indicated by a three-dimensional facility in the space (e.g., the streetlights, trees, utility poles, etc.).

At S23, the orientation of the aerial vehicle 110 following the movable platform 200 can be adjusted according to the traffic signs. For example, the position information of the movable platform 200 in the space can be obtained. Based on the position information and the traffic signs, the aerial vehicle 110 can be controlled to follow the movable platform 200 to move, and the projection of the moving trajectory of the aerial vehicle 110 on the plane can be within the area constrained by the traffic signs.

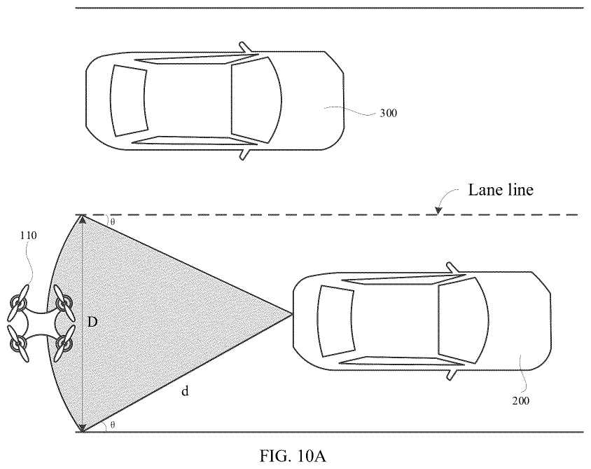

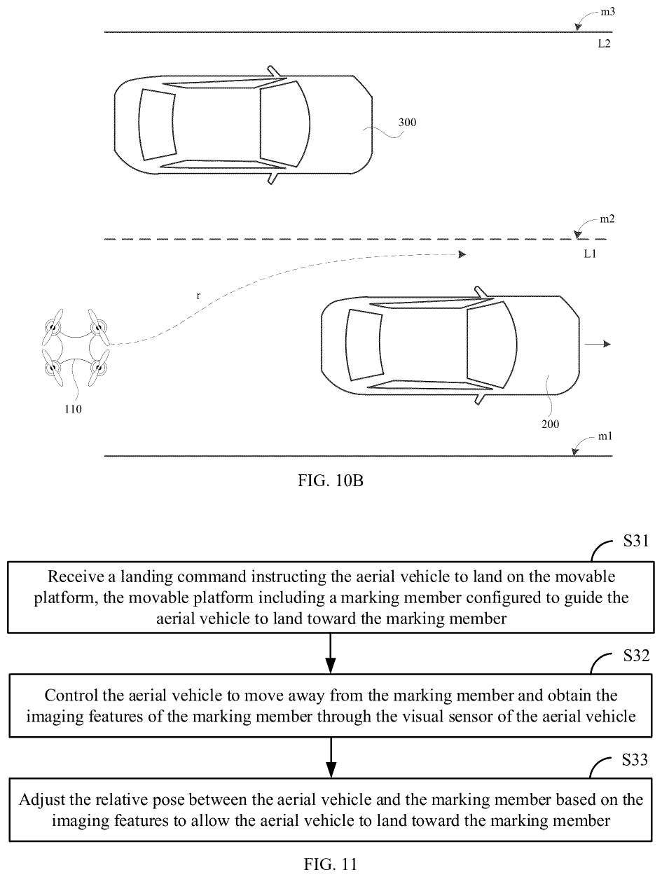

Taking the traffic sign being a lane line as an example, and as shown in FIGS. 10A and 10B, assume that the movable platform 200 moves within lane L1 constrained by lane line m1 and lane line m2. Then, the projection of the moving trajectory r of the aerial vehicle 110 in the process of following the movable platform 200 on the plane is also within lane L1. Thus, the impact of the aerial vehicle 110 following motion on other movable platforms in other lanes (e.g., a movable platform 300 in lane L2 constrained by lane line m2 and lane line m3). The blocking of the field of view of the visual sensor 123 of the aerial vehicle 110 by another movable platform can be also reduced, and the visual sensor 123 of the aerial vehicle 110 can be ensured to face directly the movable platform 200 as much as possible. Thus, the observation effect of the movable platform 200 can be improved.

In some embodiments, the traffic signs can be used to guide the moving direction of the movable platform, and the angle between the direction of the connection line between the aerial vehicle 110 and the movable platform 200 and the moving direction guided by the traffic signs can be less than a first preset angle. As shown in FIG. 10A, the gray sector area illustrates the range of the angle between the direction of the connection line between the aerial vehicle 110 and the movable platform 200 and the moving direction guided by the traffic signs. The first preset angle can be determined based on the distance d between the aerial vehicle 110 and the movable platform 200 and the lane width. Assume that the lane width is D, the first preset angle is arcsin(2d/D). The condition that the angle is less than the first preset angle can be expressed by the following formula:

$${θ}_{t} = 〈 \vec{{ρ}_{t} {p}_{t}} , {ε}_{t} 〉 < {θ}_{c} ;$$

Where, εₜ=[cos ψₜ, sin ψₜ, 0] denotes a normal vector corresponding to the angle θₜ between the direction of the connection line of the aerial vehicle 110 and the movable platform 200 and the moving direction guided by the traffic signs at time t, ψₜ∈(−π, π], θ_{c} denotes the first preset angle, Pt denotes the position of the movable platform 200 at time t, and pₜ denotes the position of the aerial vehicle 110 at time t.

In some embodiments, during the process of controlling the aerial vehicle 110 to move toward the right or left side of the movable platform 200, the moving trajectory of the aerial vehicle 110 can be also adjusted based on the category of the obstacle. With different categories of obstacles, the aerial vehicle 110 can move different distances in the direction away from the obstacle.

In some embodiments, the category of the obstacle can be determined based on whether the obstacle is movable. For example, the movable obstacles (e.g., pedestrians, other movable platforms, etc.) and the immovable obstacles (e.g., railings, traffic signs, etc.) can be determined as different categories of obstacles. In some embodiments, the movement distance of the aerial vehicle 110 away from a movable obstacle can be greater than a movement distance of the aerial vehicle away from an immovable obstacle.

In some embodiments, the category of the obstacle can also be determined based on the size of the obstacle. For example, obstacles with a size greater than or equal to the movable platform 200 (referred to as large obstacles) and obstacles with a size smaller than the movable platform 200 (referred to as small obstacles) can be determined as different categories. In some embodiments, the movement distance of the aerial vehicle 110 away from a large obstacle can be greater than the movement distance of the aerial vehicle 110 moves away from a small obstacle.

For example, the obstacle can be obstacle A1 on the front-left side of the movable platform 200. If obstacle A1 is a movable obstacle or a large obstacle, the movement distance of the aerial vehicle 110 toward the right side of the movable platform 200 can be a first distance. If obstacle A1 is an immovable obstacle or a small obstacle, the movement distance of the aerial vehicle 110 toward the right side of the movable platform 200 can be a second distance. the first distance can be greater than the second distance. Since the motion state of the movable obstacle is uncertain (e.g., the movable obstacle may suddenly accelerate or change direction), and the large obstacle has a greater blocking range for the movable platform 200, the aerial vehicle 110 may move farther away from the movable obstacle and large obstacle than from the immovable obstacle and small obstacle. The possibility of the movable platform 200 being lost from the field of view of the visual sensor 123 due to changes in the motion state of the movable obstacle or the larger blocking range of the large obstacle can be reduced.

In addition, obstacles can also be classified based on other conditions, and the moving trajectory of the aerial vehicle 110 can be adjusted based on the categories of the obstacles. The blocking of the field of view of the visual sensor 123 of the aerial vehicle 110 by an obstacle of a corresponding category can be reduced after the moving trajectory is adjusted. Thus, The possibility of the movable platform 200 being lost from the field of view of the visual sensor 123 can be reduced.

Thus, in the process of the aerial vehicle 110 following the movable platform 200, by controlling the aerial vehicle 110 to move away from the obstacle, controlling the distance between the aerial vehicle 110 and the movable platform 200, and controlling the orientation of the optical axis of the visual sensor 123, the active perception of the movable platform 200 by the aerial vehicle 110 during the follow process can be enhanced. The possibility of the movable platform 200 being lost from the field of view of the visual sensor 123 can be reduced to reduce the probability of follow failures.

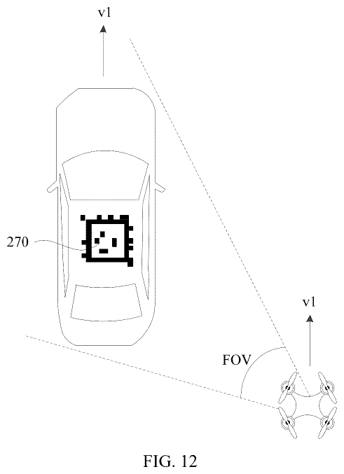

As shown in FIGS. 11 and 12, embodiments of the present disclosure also provide a control method for the aerial vehicle 110. The aerial vehicle 110 carries the visual sensor 123 for capturing images. The method includes receiving a landing command instructing the aerial vehicle 110 to land on the movable platform 200, the movable platform 200 including a marking member 270 configured to guide the aerial vehicle 110 to land toward the marking member 270 (S31), controlling the aerial vehicle 110 to move away from the marking member 270 and obtaining the imaging features of the marking member 270 through the visual sensor of the aerial vehicle 110 (S32), and adjusting the relative pose between the aerial vehicle 110 and the marking member 270 based on the imaging features to allow the aerial vehicle 110 to land toward the marking member 270 (S33).

In embodiments of the present disclosure, when the aerial vehicle 110 is landing onto the movable platform 200, the aerial vehicle 110 can be first controlled to move away from the marking member 270 of the movable platform 200 to observe the marking member 270 more completely and obtain the imaging features of the marking member 270 more comprehensively. Based on the imaging features, the aerial vehicle 110 can be controlled to land toward the marking member 270 to improve the control accuracy during the landing process and increase the success rate of the aerial vehicle 110 landing on the movable platform 200.

At S31, the landing command can be sent to the flight controller 161 of the aerial vehicle 110 by a remote control apparatus 140 or the movable platform 200. Alternatively, the flight controller 161 can automatically generate the landing command when specific conditions are met. The specific conditions can include, but are not limited to, the attitude of the aerial vehicle 110 being within a preset attitude range, the relative speed between the aerial vehicle 110 and the movable platform 200 being within a preset speed range, and/or the time length of the visual sensor 123 continuously capturing the images of the movable platform 200 being greater than a preset time length threshold. In one application scenario, the aerial vehicle 110 can first be controlled to follow the movable platform 200 to move. After receiving the landing command, the aerial vehicle 110 can be controlled to land in the method of the present disclosure. For the method for controlling the aerial vehicle 110 to follow the movable platform 200, reference can be made to the above embodiments, which is not repeated.

As shown in FIG. 12, the movable platform 200 includes a marking member 270. In some embodiments, the marking member 270 includes a reference plane including a marking pattern. The marking pattern can include a plurality of feature points. The figure illustrates that the marking pattern includes a plurality of black and white blocks. The intersections of the black and white blocks are the feature points. The figure is only exemplary, and the forms of the marking member 270 and the marking pattern of the marking member 270 are not limited to this. For example, the shape of the marking pattern can be circular, triangular, trapezoidal, or irregular, in addition to square. In some other embodiments, the marking member 270 can be a three-dimensional structure, and the marking pattern of the marking member 270 can include at least one protrusion and at least one recess. The intersections of the protrusions and recesses can be used as feature points of the marking pattern.

The marking member 270 can be arranged at the top of the movable platform 200 or at other positions. For example, if the movable platform 200 is a vehicle, the marking member 270 can be arranged in the trunk of the vehicle. The marking member 270 can be arranged at the movable platform 200 in various orientations. In some embodiments, the reference plane of the marking member 270 can be parallel to the horizontal plane. In some other embodiments, the reference plane of the marking member 270 can have a certain angle with the horizontal plane. In some embodiments, the movable platform 200 can include a carrier surface for carrying the aerial vehicle 110. The aerial vehicle 110 landing on the movable platform 200 can include the aerial vehicle 110 landing on the carrier surface of the movable platform 200. The marking member 270 can be arranged on the carrier surface.

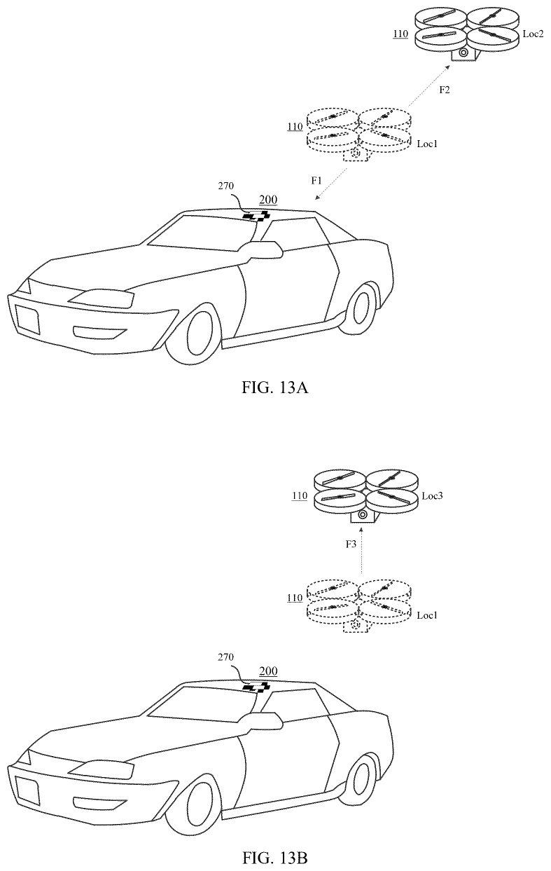

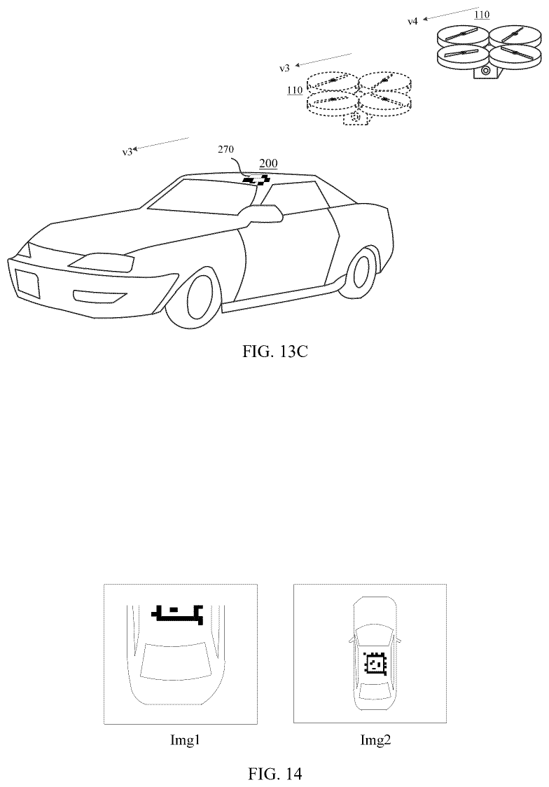

At S32, after receiving the landing command, the flight controller 161 can control the aerial vehicle 110 to move away from the marking member 270. In some embodiments, the aerial vehicle 110 can be controlled to move away from the marking member 270 in a reference direction. The reference direction can be a direction opposite to the landing direction of the aerial vehicle 110. As shown in FIG. 13A, assume that when the flight controller 161 receives the landing command, the aerial vehicle 110 is at position Loc1 (aerial vehicle 110 indicated by the dashed line illustrated in the figure). The landing direction of the aerial vehicle 110 is indicated by dashed arrow F1 in the figure. Then, the aerial vehicle 110 can be controlled to move away from the marking member 270 in direction F2 opposite to F1. After moving away, the aerial vehicle 110 is at the position Loc2 (aerial vehicle 110 indicated by the solid line illustrated in the figure). While controlling the aerial vehicle 110 moves away from the marking member 270 in the reference direction, the aerial vehicle 110 can also be controlled to move close to or far away from the marking member 270 in directions other than the reference direction, or to maintain the relative position between the aerial vehicle 110 and the marking member 270 in directions other than the reference direction unchanged.

In other embodiments, as shown in FIG. 13B, the aerial vehicle 110 is controlled to ascend vertically to move away from the marking member 270 in the vertical direction. As shown in the figure, assume that when the flight controller 161 receives the landing command, the aerial vehicle 110 is at position Loc1 (aerial vehicle 110 indicated by the dashed line illustrated in the figure). Then, the aerial vehicle 110 can be controlled to ascend vertically in direction F3. After ascending, the aerial vehicle 110 can be at position Loc3 (aerial vehicle 110 indicated by the solid line illustrated in the figure).

In yet other embodiments, as shown in FIG. 13C, the speed of the aerial vehicle 110 in the horizontal direction is reduced to form a speed difference between the aerial vehicle 110 and the movable platform 200 in the horizontal direction. The aerial vehicle 110 can be caused to move away from the marking member 270 in the horizontal direction. As shown in the figure, assume that when the flight controller 161 receives the landing command, the aerial vehicle 110 is at position Loc1 (aerial vehicle 110 indicated by the dashed line illustrated in the figure), and the aerial vehicle 110 and the movable platform 200 are moving at the same speed v3. Then, the aerial vehicle 110 can be controlled to reduce the speed of the aerial vehicle 110 to reduce from v3 to v4 (v4<v3). Then, a speed difference of v3−v4 is formed between the aerial vehicle 110 and the movable platform 200 in the horizontal direction. After a period of time, the aerial vehicle 110 will move away from the marking member 270 in the horizontal direction.

In practical applications, the aerial vehicle 110 can be controlled to move away from the marking member 270 in connection with the above two methods. For example, the aerial vehicle 110 can be controlled to ascend vertically while the speed of the aerial vehicle 110 can be reduced in the horizontal direction. Thus, the aerial vehicle 110 can move away from the marking member 270 in both the vertical and horizontal directions. The aerial vehicle 110 can be controlled to move away from the marking member 270 in other methods, which are not be listed here one by one.

While controlling the aerial vehicle 110 to move away from the marking member 270, the visual sensor 123 of the aerial vehicle 110 can also be configured to capture the images of the marking member 270. Based on the images of the marking member 270, the imaging features of the marking member 270 can be obtained. For example, the positional information of the feature points in the pattern of the marking member 270 can be obtained. Image Img1 captured by the visual sensor 123 before the aerial vehicle 110 moves away from the marking member 270 and image Img2 captured after the aerial vehicle 110 moves away from the marking member 270 are illustrated in FIG. 14. After the aerial vehicle 110 moves away from the marking member 270, the marking member 270 in image Img2 captured by the visual sensor 123 can be more complete, and more feature points can be obtained.

In some embodiments, a target visual sensor can be selected from the plurality of visual sensors 123 with different orientations of the aerial vehicle 110 to obtain the imaging features of the marking member 270. The plurality of visual sensors 123 with different orientations can include at least one first visual sensor facing downward of the aerial vehicle 110 and at least one second visual sensor facing the side of the aerial vehicle 110 (e.g., front, front-left, left, front-right, or right). By capturing the images of the marking members 270 with different attitudes (i.e., tilt angles) through different target visual sensors, the distortion of the marking member 270 in the captured images can be reduced, and the perception quality of the marking member 270 can be improved to further improve the accuracy of pose adjustment. For example, if the angle between the reference plane of the marking member 270 and the horizontal plane is less than a second preset angle, the target visual sensor can include the first visual sensor. For another example, if the pitch angle between the reference plane of the marking member 270 and the horizontal plane is greater than or equal to the second preset angle, the target visual sensor can include the second visual sensor. The second preset angle can be between 40° and 50°. For example, 45° can be set as the second preset angle.

Since the aerial vehicle 110 has certain attitude constraints when moving in the space, if a fixed visual sensor 123 is used to capture the images of the marking member 270, the images of the marking member 270 may be difficult to be captured by the visual sensor 123 under some situations. For example, when the movable platform 200 moves on a steep slope, the attitude of the marking member 270 horizontally arranged at the top of the movable platform 200 can have a relatively large angle with the horizontal plane with the movable platform 200. If the first visual sensor facing downward of the aerial vehicle 110 is always used to capture the images of the marking member 270, the quality of the captured images in the above scenario can be poor. In embodiments of the present disclosure, a target visual sensor can be selected from the plurality of visual sensors 123 with different orientations to capture the images of the marking member 270. The images of the marking members 270 of various attitudes can be effectively captured, which improves the quality of the captured images to further improve the control accuracy in the landing process of the aerial vehicle 110.

In some embodiments, the images of the marking member 270 can be captured using the first visual sensor and the second visual sensor. If the first visual sensor captures an image of the marking member 270 while the second visual sensor does not capture the image of the marking member 270, or if the completeness of the marking member 270 in the image captured by the first visual sensor is greater than the completeness of the marking member 270 in the image captured by the second visual sensor, the angle between the reference plane of the marking member 270 and the horizontal plane can be less than the second preset angle, and the target visual sensor can be determined to include the first visual sensor. If the first visual sensor does not capture an image of the marking member 270 while the second visual sensor captures an image of the marking member 270, or if the completeness of the marking member 270 in the image captured by the first visual sensor is less than or equal to the completeness of the marking member 270 in the image captured by the second visual sensor, the angle between the reference plane of the marking member 270 and the horizontal plane can be determined to be greater than or equal to the second preset angle, and the target visual sensor can be determined to include the second visual sensor.

The target visual sensor can include the first visual sensor. Only the first visual sensor can be used as the target visual sensor, or the first visual sensor and another visual sensor (e.g., a second visual sensor and/or other visual sensors of the aerial vehicle 110) can be together used as the target visual sensor. Similarly, the target visual sensor can include the second visual sensor. Only the second visual sensor can be used as the target visual sensor, or the second visual sensor and another visual sensor (e.g., the first visual sensor and/or other visual sensors of the aerial vehicle 110) can be used as the target visual sensor.

In some embodiments, if the angle between the reference plane of the marking member 270 and the horizontal plane is less than the second preset angle, and/or the target visual sensor includes the first visual sensor, controlling the aerial vehicle 110 to move away from the marking member 270 can at least include controlling the aerial vehicle 110 to ascend vertically to cause the aerial vehicle 110 to move away from the marking member 270 in the vertical direction. In some other embodiments, if the angle between the reference plane of the marking member 270 and the horizontal plane is greater than or equal to the second preset angle, and/or the target visual sensor includes the second visual sensor, controlling the aerial vehicle 110 to move away from the marking member 270 can at least include reducing the speed of the aerial vehicle 110 in the horizontal direction to form a speed difference between the aerial vehicle 110 and the movable platform 200 in the horizontal direction to allow the aerial vehicle 110 to move away from the marking member 270 in the horizontal direction due to the speed difference.

In some embodiments, the first height change of the aerial vehicle 110 can be greater than the second height change of the aerial vehicle 110. The first height change can be the height change in the vertical direction when the aerial vehicle 110 is landing onto the movable platform 200 when the target visual sensor includes the first visual sensor. The second height change can be the height change in the vertical direction when the aerial vehicle 110 is landing onto the movable platform 200 when the target visual sensor includes the second visual sensor.

In some embodiments, the marking member 270 can be arranged on the carrier surface. When the carrier surface has different inclination angles, the landing trajectory of the aerial vehicle 110 can have different ascending distances in the vertical direction during the landing process. If the angle between the carrier surface and the horizontal plane is less than a third preset angle, the aerial vehicle 110 may need to ascend to a relatively high height to observe the whole marking member 270 on the ground. Thus, when the angle between the carrier surface and the horizontal plane is less than the third preset angle, the landing trajectory of the aerial vehicle 110 can have relatively large ascending distance in the vertical direction. When the angle between the carrier surface and the horizontal plane is greater than the third preset angle, the landing trajectory of the aerial vehicle 110 can have relatively small ascending distance in the vertical direction.

In some embodiments, during the process of obtaining the imaging features of the marking member 270 through the visual sensor 123 of the aerial vehicle 110, the moving trajectory of the aerial vehicle 110 can also be controlled to cause the marking member 270 to be positioned at a specified location in the image captured by the visual sensor 123. In some embodiments, since the central area of the image has less distortion and higher imaging quality, the specified location can be the central area of the image. In other embodiments, the specified area can also be the upper-left area, lower-right area, left area, or right area of the image. Taking the specified area being the central area of the image as an example, to improve the perception quality of the marking member 270, during the process of the visual sensor 123 obtaining the imaging features of the marking member 270, the marking member 270 can be kept in the central area of the image for as long as possible. In some embodiments, the marking member 270 can be maintained in the central area of the image by adjusting the moving trajectory of the arial vehicle 110, the attitude of the aerial vehicle 110 and/or the attitude of the gimbal 120 for carrying the visual sensor 123.

At S33, the relative pose between the aerial vehicle 110 and the marking member 270 can be adjusted based on the imaging features of the marking member 270. For example, the relative pose between the aerial vehicle 110 and the marking member 270 when capturing the image of the marking member 270 can be determined based on the position information of the feature points in the image pattern of the marking member 270, and the pose of the aerial vehicle 110 can be adjusted to gradually reduce the relative pose. During the process of adjusting the relative pose, the aerial vehicle 110 can gradually land toward the marking member 270. At the moment when the aerial vehicle 110 contacts the movable platform, the statuses, such as positions, speeds, and attitudes, of the aerial vehicle 110 and the marking member 270 can remain aligned. That is, the position difference, speed difference, and attitude difference between the aerial vehicle 110 and the marking member 270 can be within corresponding preset ranges. This landing method can be referred to as end-state-aligned landing.

In some embodiments, during the process of the aerial vehicle 110 landing toward the marking member 270, the trajectory of the aerial vehicle 110 includes a segment where the altitude first decreases and then increases. In the altitude-decreasing segment, the aerial vehicle 110 can be controlled to accelerate to catch up with the movable platform 200. In the altitude-increasing segment, the aerial vehicle 110 can be controlled to adjust its relative pose with the marking member 270 and decelerate to land on the movable platform 200.

Furthermore, in the trajectory segment where the height first decreases and then increases, the minimum height of the trajectory points of the aerial vehicle 110 can be lower than the height of the marking member 270. Referring to FIG. 15, before the aerial vehicle 110 lands, the distance between the aerial vehicle 110 and the movable platform 200 is relatively large. To reduce the distance between the aerial vehicle 110 and the movable platform 200, the aerial vehicle 110 may need to move at a speed greater than the speed of the movable platform 200 in the trajectory segment where the height decreases. Thus, before landing, the aerial vehicle 110 may need to be decelerated. Then, the aerial vehicle 110 can be aligned with the movable platform 200 when the aerial vehicle 110 is on the movable platform 200. However, in the process of decelerating, the aerial vehicle 110 may be subjected to a force f tilted upward, and the aerial vehicle 110 can ascend under the force f. Thus, to ensure that the aerial vehicle 110 can move toward the marking member 270, in the trajectory segment where the aerial vehicle 110 first descend and then ascend, the smallest value h1 of the height of the trajectory points of the aerial vehicle 110 may need to be smaller than the height h2 of the marking member 270 to compensate the height that the aerial vehicle 110 ascend due to the force f.

In some embodiments, during the process of the aerial vehicle 110 landing toward the marking member 270, the trajectory of the aerial vehicle 110 can sequentially include a first trajectory segment for the height decrease, a second trajectory segment for the height increase, and a third trajectory segment for the height decrease. The height that the aerial vehicle 110 descends in the first trajectory segment can be larger than the height that the aerial vehicle 110 descends in the third trajectory segment.

The first trajectory segment can be the trajectory segment for the height decrease in the trajectory segment where the aerial vehicle 110 first descends and then ascends. The second trajectory segment can be the trajectory segment for the height increase in the trajectory segment where the aerial vehicle 110 first descends and then ascends. In the trajectory segment for the height increase, the largest height that the aerial vehicle 110 ascends can be slightly larger than the height of the marking member 270. In the third trajectory segment, the aerial vehicle 110 can slightly descend. Thus, the aerial vehicle 110 can land onto the movable platform 200. For example, in the third trajectory segment, the motor 152 of the aerial vehicle 110 can be powered off to cause the aerial vehicle 110 to land onto the movable platform 200 in free fall.

In the trajectory segment for height increase and the trajectory segment for height decrease, the aerial vehicle 110 can ascend or descend in stages or continuously. By taking the trajectory segment for height increase as an example, the aerial vehicle 110 can be controlled to ascend in the first time period. Then, the height of the aerial vehicle 110 can be maintained unchanged in the second time period after the first time period. Then, the aerial vehicle 110 can be controlled to ascend in the third time period after the second time period. Thus, the trajectory segment for height increase can be generated through a plurality of non-continuous ascending processes. In some other embodiments, the aerial vehicle 110 can be controlled to continuously ascend in the first time period until the expected height. The descending process can be similar to the ascending process, which is not repeated here.

FIG. 16 is a schematic diagram showing a whole trajectory of the aerial vehicle 110 a during landing process consistent with the disclosure. The whole trajectory includes trajectory segments Tr0, Tr1, Tr2, and Tr3. Trajectory segment Tr0 corresponds to the trajectory segment in which the aerial vehicle 110 is controlled to move away from the marking member 270 at S32. Trajectory segments Tr1, Tr2, and Tr3 correspond to the first trajectory segment, second trajectory segment, and third trajectory segment, respectively. By controlling the aerial vehicle 110 to land on the movable platform 200 in the above method, the trajectory energy of the aerial vehicle 110 can be minimized to reduce jitter during the landing process of the aerial vehicle 110. The trajectory energy can refer to the integral of the acceleration of the aerial vehicle 110 at the trajectory points. When the trajectory energy is larger, the jitter for the aerial vehicle 110 during the landing process can be larger.

In some embodiments, during the process of the aerial vehicle 110 landing toward the marking member 270 of the movable platform 200, if the motion state of the marking member 270 is detected to not meet the preset moving condition, the aerial vehicle 110 can be controlled to move away from the marking member 270. The preset moving condition can include that the change amount in the motion state of the marking member 270 is less than a preset change amount threshold. The motion state can be characterized by position, speed, or acceleration. For example, if the position change amount of the marking member 270 exceeds a preset distance threshold, the speed change amount of the marking member 270 exceeds a preset speed threshold, and/or the acceleration change amount of the marking member 270 exceeds a preset acceleration threshold, the motion state of the marking member 270 can be determined to not meet the preset moving condition. The motion state of the marking member 270 can be determined according to the plurality of images of the marking member 270 captured by the visual sensor 123 at different moments. If the motion state of the marking member 270 does not meet the preset moving condition, the current landing can be terminated, and the aerial vehicle 110 can be controlled to move away from the marking member 270. After the aerial vehicle 110 is controlled to move away from the marking member 270, processes S32 and S33 can be re-executed to control the aerial vehicle 110 to land again. Alternatively, the aerial vehicle 110 can be controlled to follow the movable platform 200, and after the landing command is received again, the aerial vehicle 110 can be controlled to land again.

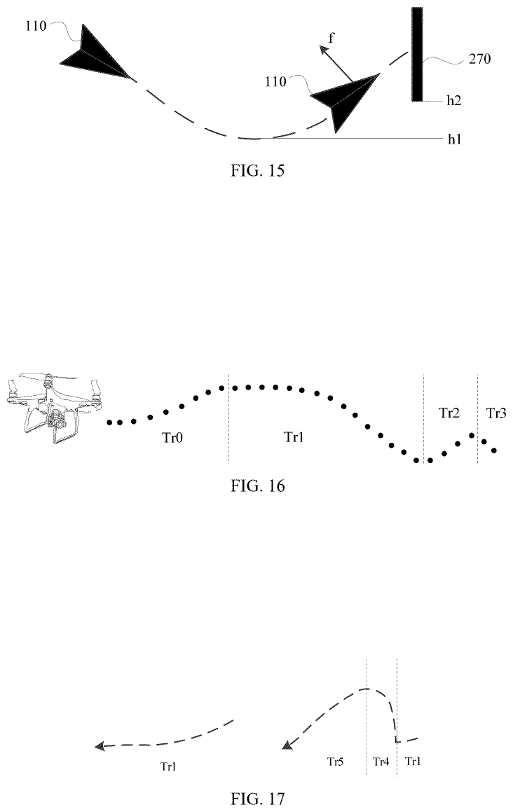

The trajectory on the left side of FIG. 17 shows a trajectory segment Tr1 for descending when the motion state of the marking member 270 meets the preset moving condition. In the process of controlling the aerial vehicle 110 to perform the trajectory segment Tr1 for descending, assume that the motion state of the marking member 270 is detected to not meet the preset moving condition, as shown in the trajectory segment on the right side of FIG. 17, the trajectory segment Tr1 for descending is terminated. The aerial vehicle 110 can execute the trajectory segment upward to cause the aerial vehicle 110 to move away from the marking member 270. After the aerial vehicle 110 moves away from the marking member 270, the aerial vehicle 110 can be controlled to execute the trajectory segment Tr5 downward to allow the aerial vehicle 110 to attempt to land onto the movable platform 200 again.

During the landing process of the aerial vehicle 110, the distance between the aerial vehicle 110 and the movable platform 200 can gradually decrease. If the motion state of the movable platform 200 has a sudden change, the remaining spatial margin is often insufficient for the aerial vehicle 110 to complete an end-state-aligned landing with the movable platform 200 while satisfying a dynamic condition. Therefore, in embodiments of the present disclosure, by controlling the aerial vehicle 110 to move away from the marking member 270, landing failures due to insufficient remaining spatial margin can be reduced to ensure that the aerial vehicle 110 can land on the movable platform 200 while satisfying the end-state aligned condition. Thus, the safety of the aerial vehicle 110 can be improved. Additionally, during the landing process, if the distance between the aerial vehicle 110 and the movable platform 200 is relatively close, the marking member 270 may fall outside the field of view of the visual sensor 123. By re-controlling the aerial vehicle 110 to move away from the marking member 270, the visual sensor 123 can re-observe the marking member 270 to ensure accurate control over the landing process of the aerial vehicle 110.

In addition, detecting that the motion state of the marking member 270 does not meet the preset moving condition may also be caused by observation errors. Since the movement of the movable platform 200 in space is constrained by the physical world, extremely large sudden changes in positions, speeds, or accelerations may not happen. If an extremely large sudden change happens, an observation error may occur. Thus, the landing failure can be determined, and the aerial vehicle 110 can be re-controlled to move away from the marking member 270.

In some embodiments, if the marking member 270 is lost from the field of view of the visual sensor 123, and the loss time length exceeds a preset time length threshold, a landing failure can be determined, and the aerial vehicle 110 can be re-controlled to move away from the marking member 270.

In some embodiments, when the distance between the aerial vehicle 110 and the marking member 270 is less than a preset distance threshold, the rotor plane of the aerial vehicle 110 can remain parallel to the carrier surface of the movable platform 200. The rotor plane of the aerial vehicle 110 can refer to the plane formed by the rotors 153 of the aerial vehicle 110. By keeping the rotor plane of the aerial vehicle 110 parallel to the carrier surface of the movable platform 200 when the distance between the aerial vehicle 110 and the marking member 270 is less than the preset distance threshold, collisions between the rotors 153 and the carrier surface during rotation can be avoided to reduce physical wear on the aerial vehicle 110 and improve the safety of the aerial vehicle 110 during the landing process.

In some embodiments, before the aerial vehicle 110 contacts the carrier surface of the movable platform 200, the thrust of the aerial vehicle 110 can be reduced to within a preset thrust range. The thrust of the aerial vehicle 110 can be used to control the speed component of the aerial vehicle 110's movement in the vertical direction to decrease. Before the aerial vehicle 110 contacts the carrier surface of the movable platform 200, the speed component of the aerial vehicle 110 in the vertical direction can be essentially zero, so the thrust of the aerial vehicle 110 can be reduced.

In some embodiments, before the aerial vehicle 110 contacts the carrier surface of the movable platform 200, the rotation speed of the motor 152 of the aerial vehicle 110 can be reduced to within a preset speed range. Since when the aerial vehicle 110 approaches the carrier surface, the airflow generated when the rotors 153 rotate can cause the aerial vehicle 110 to drift to affect the landing position of the aerial vehicle 110. Therefore, reducing the rotation speed of the motor 152 before the aerial vehicle 110 contacts the carrier surface of the movable platform 200 can reduce the drift of the aerial vehicle 110 to improve the control accuracy during the landing process. In some embodiments, the motor 152 can be directly powered off to stop the rotors of the aerial vehicle 110 to allow the aerial vehicle 110 to land on the carrier surface in free fall from a position close to the carrier surface.

In some embodiments, the landing time of the aerial vehicle 110 on the movable platform 200 can be predicted. The relative displacement between the aerial vehicle 110 and the movable platform 200 in the moving direction of the movable platform 200 can be predicted for the predicted landing time. If the predicted relative displacement is less than a preset displacement threshold, the rotation speed of the motor 152 of the aerial vehicle 110 can be reduced.

In some embodiments, the aerial vehicle 110 can be controlled to land toward the carrier surface of the movable platform 200. Before the aerial vehicle 110 contacts the carrier surface of the movable platform 200, the thrust of the aerial vehicle 110 can be reduced to within the preset thrust range, and/or the rotation speed of the motor 152 of the aerial vehicle 110 can be reduced to within a preset rotation speed range.

In some embodiments, the landing time of the aerial vehicle 110 on the movable platform 200 can be predicted based on the current height difference between the aerial vehicle 110 and the movable platform 200. Then, based on the current speed of the aerial vehicle 110, the current speed of the movable platform 200, and the predicted landing time, the relative displacement between the aerial vehicle 110 and the movable platform 200 in the moving direction of the movable platform 200 can be predicted with the predicted landing time.

Furthermore, the relative displacement Eₕ(t_{cur}) between the aerial vehicle 110 and the movable platform 200 in the moving direction of the movable platform 200 can be calculated at the current time, and the relative displacement Eₕ(t_{cur}+Δt) between the aerial vehicle 110 and the movable platform 200 in the moving direction of the movable platform 200 can be calculated after a time interval Δt. If Eₕ(t_{cur}+Δt)<Eₕ(t_{cur}), it indicates that the relative displacement is further decreasing. Then, the aerial vehicle 110 can continue to be controlled to land at the current rotation speed of the motor. If Eₕ(t_{cur}+Δt)>Eₕ(t_{cur}), it indicates that the relative displacement is increasing. If the relative displacement Eₕ(t_{cur}) is less than the preset landing distance threshold dₛₜₒₚ, the rotation speed of the motor 152 of the aerial vehicle 110 can be reduced. If the relative displacement Eₕ(t_{cur}) is greater than or equal to the landing distance threshold dₛₜₒₚ, a landing failure can be determined, and the aerial vehicle 110 can be re-controlled to move away from the marking member 270.

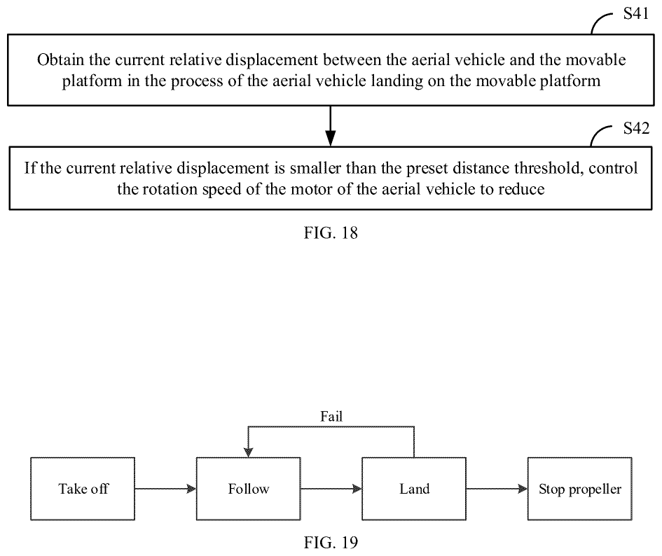

As shown in FIG. 18, embodiments of the present disclosure also provide a control method for the aerial vehicle 110. The method includes obtaining the current relative displacement between the aerial vehicle 110 and the movable platform 200 in the process of the aerial vehicle 110 landing onto the movable platform 200 (S41), and if the current relative displacement is smaller than the preset distance threshold, controlling the rotation speed of the motor 152 of the aerial vehicle 110 to reduce (S42).

In some embodiments, the current relative displacement can be the relative displacement Eₕ(t_{cur}) between the aerial vehicle 110 and the movable platform 200 in the moving direction of the movable platform 200 at the current moment. If the relative displacement Eₕ(t_{cur}) is less than the preset landing distance threshold dₛₜₒₚ, the rotation speed of the motor 152 of the aerial vehicle 110 can be reduced. If the relative displacement Eₕ(t_{cur}) is greater than or equal to the landing distance threshold dₛₜₒₚ, a landing failure can be determined, and the aerial vehicle 110 can be controlled to move away from the movable platform 200. Furthermore, the movable platform 200 can include the marking member 270 to enhance perception during the landing process of the aerial vehicle 110. Controlling the aerial vehicle 110 to move away from the movable platform 200 can include controlling the aerial vehicle 110 to move away from the marking member 270. For specific implementations, reference can be made to the above embodiments, which are not repeated here.

Further, the landing time of the aerial vehicle 110 on the movable platform 200 can be predicted. The relative displacement between the aerial vehicle 110 and the movable platform 200 at the landing time can be predicted. If the predicted relative displacement is less than the preset displacement threshold, the rotation speed of the motor 152 of the aerial vehicle 110 can be reduced.

In embodiments of the present disclosure, before the aerial vehicle 110 lands on the movable platform 200, as long as the current relative displacement between the aerial vehicle 110 and the movable platform 200 is less than the preset distance threshold, the rotation speed of the motor 152 of the aerial vehicle 110 can be reduced in advance. Thus, the impact of the airflow generated when the rotors 153 rotate on the position of the aerial vehicle 110 to further improve control accuracy during the landing process.

FIG. 19 is a schematic flowchart of a control process for the aerial vehicle 110 consistent with the disclosure. After the aerial vehicle 110 takes off, the aerial vehicle 110 can be controlled to follow the movable platform 200. During the follow process, if a landing command is received, and the movable platform 200 is determined to be in a relatively stable motion state, the aerial vehicle 110 can be controlled to land. If the landing fails (e.g., the motion state of the movable platform 200 does not meet the preset moving condition), the aerial vehicle 110 can be re-controlled to follow the movable platform 200. In some embodiments, during the re-follow process, the aerial vehicle 110 can be controlled to move away from the marking member 270 of the movable platform 200. If the landing is successful, the aerial vehicle 110 can be controlled to stop the rotors. In some other embodiments, if the landing is determined to be successful, the aerial vehicle 110 can be controlled to stop the rotors before the aerial vehicle 110 contacts the carrier surface of the movable platform 200.

Embodiments of the present disclosure also provide a control apparatus for the aerial vehicle 110. The aerial vehicle 110 can carry a visual sensor 123 for capturing images. The apparatus can include a processor. The processor can be configured to control the aerial vehicle 110 to follow the movable platform 200 based on the images of the movable platform 200 captured by the visual sensor 123, during the process of following the movable platform 200, determine whether an obstacle exists on the front-left or front-right side in the moving direction of the movable platform 200, and if the obstacle is determined to be on the front-left side, control the aerial vehicle 110 to move toward the right side of the movable platform 200, and if the obstacle is determined to be on the front-right side, control the aerial vehicle 110 to move toward the left side of the movable platform 200.

In some embodiments, during the process of controlling the aerial vehicle 110 to move toward the right or left side of the movable platform 200, the angle between the orientation of the visual sensor 123 of the aerial vehicle 110 and the moving direction of the movable platform 200 can gradually increase. In some embodiments, the angle can gradually increase within a first preset angle range.

In some embodiments, in some moments of controlling the aerial vehicle 110 to move toward the right or left side of the movable platform 200, the distance between the movable platform 200 and the obstacle can be less than the distance between the aerial vehicle 110 and the obstacle at the same moment.

In some embodiments, during the process of controlling the aerial vehicle 110 to move toward the right or left side of the movable platform 200, the orientation of the visual sensor 123 can be inconsistent with the moving direction of the aerial vehicle 110.

In some embodiments, in some moments of controlling the aerial vehicle 110 to move toward the right or left side of the movable platform 200, the moving speed of the aerial vehicle 110 can be greater than the moving speed of the movable platform 200.

In some embodiments, in some moments of controlling the aerial vehicle 110 to move toward the right or left side of the movable platform 200, the speed component of the moving speed of the aerial vehicle 110 in the moving direction of the movable platform 200 can be greater than the moving speed of the movable platform 200 in the moving direction.

In some embodiments, during the process of controlling the aerial vehicle 110 to move toward the right or left side of the movable platform 200, the distance between the aerial vehicle 110 and the movable platform 200 can be maintained within a preset distance range.

In some embodiments, during the process of controlling the aerial vehicle 110 to move toward the right or left side of the movable platform 200, the angle between orientation of the optical axis of the visual sensor 123 and the orientation of the connection line between the movable platform 200 and the aerial vehicle 110 can be within a second preset angle range.

Embodiments of the present disclosure also provide a control apparatus for the aerial vehicle 110. The apparatus can include a processor. The processor can be further configured to obtain the traffic signs in the space where the movable platform 200 is located and adjust the moving trajectory of the aerial vehicle 110 based on the traffic signs.

In some embodiments, the processor can be configured to adjust the orientation of the aerial vehicle 110 following the movable platform 200 based on the traffic signs.

In some embodiments, the processor can be configured to obtain the position information of the movable platform 200 in the space, and based on the position information and the traffic signs, control the aerial vehicle 110 to follow the movable platform 200, and ensure the projection of the moving trajectory of the aerial vehicle 110 on the plane to be within the area constrained by the traffic signs during the movement of the aerial vehicle 110.

In some embodiments, the traffic signs can be used to guide the moving direction of the movable platform 200. The angle between the direction pointed by the connection line between the aerial vehicle 110 and the movable platform 200 and the moving direction guided by the traffic signs can be less than a first preset angle.

In some embodiments, during the process of controlling the aerial vehicle 110 to move toward the right or left side of the movable platform 200, the moving trajectory of the aerial vehicle 110 can be also adjusted based on the category of the obstacle.

Embodiments of the present disclosure also provide a control apparatus for the aerial vehicle 110. The apparatus can include a processor. The processor can be further configured to receive a landing command instructing the aerial vehicle 110 to land on the movable platform 200, where the movable platform 200 includes a marking member 270 for guiding the aerial vehicle 110 to land toward the marking member 270, control the aerial vehicle 110 to move away from the marking member 270 and obtain the imaging features of the marking member 270 through the visual sensor 123 on the aerial vehicle 110, adjust the relative pose between the aerial vehicle 110 and the marking member 270 based on the imaging features, and allow the aerial vehicle 110 to land toward the marking member 270 after pose adjustment.

In some embodiments, the processor can be configured to control the aerial vehicle 110 to move away from the marking member 270 in a reference direction. The reference direction can be opposite to the landing direction of the aerial vehicle 110.

In some embodiments, the processor can be configured to control the aerial vehicle 110 to ascend vertically to cause the aerial vehicle 110 to move away from the marking member 270 in the vertical direction and/or reduce the speed of the aerial vehicle 110 in the horizontal direction to form a speed difference between the aerial vehicle 110 and the movable platform 200 in the horizontal direction to cause the aerial vehicle 110 to move from the marking member 270 in the horizontal direction due to the speed difference.

In some embodiments, the processor can be configured to select a target visual sensor 123 from the plurality of visual sensors 123 with different orientations on the aerial vehicle 110 to obtain the imaging features of the marking member 270.

In some embodiments, the marking member 270 can include a reference plane with a marking pattern. If the angle between the reference plane of the marking member 270 and the horizontal plane is less than a second preset angle, the target visual sensor 123 can include the first visual sensor 123. If the pitch angle between the reference plane of the marking member 270 and the horizontal plane is greater than or equal to the second preset angle, the target visual sensor 123 can include the second visual sensor 123. The first visual sensor 123 can face downward of the aerial vehicle 110, and the second visual sensor 123 can face the side of the aerial vehicle 110.

In some embodiments, the movable platform 200 can include a carrier surface for carrying the aerial vehicle 110. The marking member 270 can be arranged on the carrier surface.

In some embodiments, the processor can be further configured to during the process of obtaining the imaging features of the marking member 270 through the visual sensor 123 of the aerial vehicle 110, control the moving trajectory of the aerial vehicle 110 to ensure the marking member 270 to be positioned at a specified position in the image captured by the visual sensor 123.

In some embodiments, during the process of the aerial vehicle 110 landing toward the marking member 270, the trajectory of the aerial vehicle 110 can include the segment where the aerial vehicle descend first and then ascend.

In some embodiments, in the trajectory segment, the smallest height of the trajectory points of the aerial vehicle 110 can be lower than the height of the marking member 270.

In some embodiments, during the process of the aerial vehicle 110 descending toward the marking member 270, the trajectory of the aerial vehicle 110 sequentially includes the following segments: a first altitude-decreasing segment, a second altitude-increasing segment, and a third altitude-decreasing segment. The altitude decrease in the first segment is greater than the altitude decrease in the third segment.

In some embodiments, the processor can be further configured to during the process of the aerial vehicle 110 landing toward the marking member 270 of the movable platform 200, if the motion state of the marking member 270 is detected to not meet the preset moving condition, control the aerial vehicle 110 to move away from the marking member 270.

In some embodiments, when the distance between the aerial vehicle 110 and the marking member 270 is less than a preset distance threshold, the rotor plane of the aerial vehicle 110 can remain parallel to the carrier surface of the movable platform 200.

In some embodiments, before the aerial vehicle 110 contacts the carrier surface of the movable platform 200, the thrust of the aerial vehicle 110 can be reduced to within a preset thrust range, and/or the rotation speed of the motor 152 of the aerial vehicle 110 can be reduced to within a preset rotation speed range.

In some embodiments, the processor can be further configured to predict the landing time of the aerial vehicle 110 on the movable platform 200, predict the relative displacement between the aerial vehicle 110 and the movable platform 200 in the moving direction of the movable platform 200 at the predicted landing time, if the predicted relative displacement is less than a preset displacement threshold, reduce the rotation speed of the motor 152 of the aerial vehicle 110.

Embodiments of the present disclosure can also provide a control apparatus for the aerial vehicle 110. The apparatus can include a processor. The processor can be further configured to during the process of the aerial vehicle 110 landing onto the movable platform 200, obtain the current relative displacement between the aerial vehicle 110 and the movable platform 200, and if the current relative displacement is less than a preset distance threshold, reduce the rotation speed of the motor 152 of the aerial vehicle 110.

In some embodiments, the processor can be further configured to control the aerial vehicle 110 to land toward the carrier surface of the movable platform 200, control the thrust of the aerial vehicle 110 to reduce to the present thrust range before the aerial vehicle 110 contacts the carrier surface of the movable platform 200, and/or reduce the rotation speed of the motor of the aerial vehicle 110 to be within the preset rotation speed range.

In some embodiments, the processor can be specifically configured to predict the landing time of the aerial vehicle 110 on the movable platform 200, predict the relative displacement between the aerial vehicle 110 and the movable platform 200 at the landing time, and if the predicted relative displacement is less than the preset displacement threshold, control the rotation speed of the motor 152 of the aerial vehicle 110 to decrease.

Embodiments of the present disclosure further provide a control apparatus for the aerial vehicle 110. The apparatus can include a processor. The processor can be further configured to control the aerial vehicle 110 to follow the movement of the movable platform 200 based on the images of the movable platform 200 captured by the visual sensor 123, determine whether an obstacle exists on the inner side of the turning direction of the movable platform 200 when following the movable platform 200, and if the obstacle is determined on the inner side of the turning direction, control the aerial vehicle 110 to move toward the outer side of the turning direction.

For the functions executed by the processor in the above apparatus embodiments, reference can be made to the above method embodiments, which are not repeated.

Embodiments of the present disclosure further provide a computer-readable storage medium storing a computer program that, when executed by the processor, causes the processor to perform any method above.

The computer-readable medium can include permanent and non-permanent, movable and non-movable media that can store information in any method or technology. The information can include computer-readable instructions, data structures, program modules, or other data. The computer storage media can include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory, or other memory technologies; compact disc read-only memory (CD-ROM), digital versatile discs (DVDs), or other optical storage; magnetic tape cassettes, magnetic tapes, magnetic disk storage, or other magnetic storage devices, or any other non-transitory medium that can be used to store information accessible by a computing device. As defined here, the computer-readable medium may not include transitory computer-readable media, such as modulated data signals and carrier waves.

Embodiments of the present disclosure further provide an aerial vehicle 110. The aerial vehicle 110 can include a visual sensor 123 and a flight controller 161.

The visual sensor 123 can be configured to obtain the images of the movable platform 200.

The flight controller 161 can be configured to control the aerial vehicle 110 to follow the movable platform 200 in space based on the obtained images, determine whether an obstacle exists on the left front side or right front side of the movement direction of the movable platform 200 during the follow process, if an obstacle is determined to exist on the left front side, control the aerial vehicle 110 to move toward the right side of the movable platform 200, and if an obstacle is determined to exist on the right front side, control the aerial vehicle 110 to move toward the left side of the movable platform 200.

Embodiments of the present disclosure further provide an aerial vehicle 110. The aerial vehicle 110 can include a visual sensor 123 and a flight controller 161.

The visual sensor 123 can be configured to obtain the imaging features of a marking member 270 on the movable platform 200. The marker 270 can be used to guide the aerial vehicle 110 to land toward the marking member 270.

The flight controller 161 can be configured to receive a landing command used to instruct that the aerial vehicle 110 to land on the movable platform 200, control the aerial vehicle 110 to move away from the marker 270, adjust the relative pose between the aerial vehicle 110 and the marking member 270 based on the imaging features, and allow the aerial vehicle 110 to land toward the marking member 270 after the pose adjustment.

Embodiments of the present disclosure further provide an aerial vehicle 110. The aerial vehicle 110 can include a motor 152 and a flight controller 161.

The motor 152 can be configured to provide power for the flight of the aerial vehicle 110.

The flight controller 161 can be configured to obtain the current relative displacement between the aerial vehicle 110 and the movable platform 200 when the aerial vehicle 110 is landing onto the movable platform 200, and if the current relative displacement is less than the preset distance threshold, control the rotation speed of the motor 152 of the aerial vehicle 110 to decrease.

From the description of the above embodiments, those skilled in the art can understand that embodiments of the present disclosure can be implemented in the form of software in combination with a necessary general hardware platform. Based on this understanding, the technical solutions of embodiments of the present disclosure can essentially be expressed in the form of a software product. The computer software product can be stored in a storage medium, such as ROM/RAM, magnetic disks, optical disks, etc., and include a plurality of commands to allow the computing device (e.g., a personal computer, server, or network device, etc.) to execute all or part of the methods described in embodiments of the present disclosure.

The system, apparatus, module, or unit described in the above embodiments can be implemented by a computer chip or a physical entity or by a product with a certain function. A typical implementation device can be a computer. The computer can include a personal computer, laptop, mobile phone, camera phone, smartphone, personal digital assistant, media player, navigation device, email device, game console, tablet computer, wearable device, or a combination thereof.

The technical features of embodiments of the present disclosure can be arbitrarily combined as long as there is no conflict or contradiction between the features, which are not listed one-by-one. Thus, arbitrary combinations of the technical solutions of embodiments of the present disclosure are also within the scope of the present disclosure.

Those skilled in the art can easily think of other embodiments of the present disclosure by considering the present disclosure and implementing the description of the present disclosure. The present disclosure is intended to cover any modifications, uses, or adaptations. The modifications, uses, or adaptations follow the general principles of the present disclosure and include commonly known knowledge or common technical means of the present disclosure. The specification and embodiments are illustrative. The scope and spirit of the present disclosure should be defined by the following claims.

The present disclosure is not limited to the accurate structures described above and illustrated in the accompanying drawings, and various modifications and changes can be made without departing from the scope of the present disclosure. The scope of the present disclosure is only limited by the appended claims.

The above are merely some embodiments of the present disclosure and are not intended to limit the present disclosure. Any modifications, equivalent replacements, or improvements made within the spirit and principles of the present disclosure should be within the scope of the present disclosure.

What is claimed is:

1. An aerial vehicle control method comprising:
controlling an aerial vehicle to follow a movable platform to move based on an image of the movable platform collected by a visual sensor carried by the aerial vehicle;
in a process of following the movable platform to move, controlling the aerial vehicle to move to a right side of the movable platform in response to an obstacle existing on a left front side of a moving direction of the movable platform; and
in the process of following the movable platform to move, controlling the aerial vehicle to move to a left side of the movable platform in response to an obstacle existing on a right front side of the moving direction of the movable platform.

2. The method according to claim 1, wherein controlling the aerial vehicle to move to the right side of the movable platform in response to the obstacle existing on the left front side of the moving direction of the movable platform includes:
controlling the aerial vehicle to move to the right side of the movable platform in response to the obstacle existing on the left front side and located at an inner side of a turning direction of the movable platform.

3. The method according to claim 1, wherein controlling the aerial vehicle to move to the left side of the movable platform in response to the obstacle existing on the right front side of the moving direction of the movable platform includes:
controlling the aerial vehicle to move to the left side of the movable platform in response to the obstacle existing on the right front side and being located at an inner side of a turning direction of the movable platform.

4. The method according to claim 1, further comprising:
in the process of following the movable platform, in response to no obstacle existing, maintaining the aerial vehicle to follow the movable platform at a rear side of the movable platform.

5. The method according to claim 1, wherein controlling the aerial vehicle to move to the right side or the left side of the movable platform includes at least one of:
controlling an angle between an orientation of the visual sensor and the moving direction of the movable platform to gradually increase in a first preset angle range;
controlling a distance between the movable platform and the obstacle to be smaller than a distance between the aerial vehicle and the obstacle at a same moment;
controlling the orientation of the visual sensor to be inconsistent with a moving direction of the aerial vehicle;
controlling a distance between the aerial vehicle and the movable platform to remain in a preset distance range;
controlling an angle between an orientation of an optical axis of the visual sensor and an orientation of a connection line between the movable platform and the aerial vehicle to be in a second preset angle range; or
adjusting a moving trajectory of the aerial vehicle based on a category of the obstacle.

6. The method according to claim 1, further comprising:
obtaining a traffic sign in a space where the movable platform is located; and
adjusting an orientation of the aerial vehicle following the movable platform according to the traffic sign.

7. The method according to claim 6, wherein:
the traffic sign instructs the movable platform to move in a constrained area; and
a projection of a moving trajectory of the aerial vehicle following the movable platform on a plane is in the constrained area.

8. The method according to claim 7, wherein:
the traffic sign guides the moving direction of the movable platform; and
an angle between an orientation of a connection line between the aerial vehicle and the movable platform and the moving direction guided by the traffic sign is smaller than a preset angle to allow the projection of the moving trajectory of the aerial vehicle following the movable platform on the plane where the movable platform is to be in a flight path of the movable platform.

9. The method according to claim 1, further comprising:
receiving a landing instruction to instruct the aerial vehicle to land on the movable platform, the movable platform including a marking member configured to guide the aerial vehicle to land toward the marking member;
controlling the aerial vehicle to move away from the marking member and obtaining an imaging feature of the marking member through the visual sensor of the aerial vehicle; and
adjusting a relative attitude between the aerial vehicle and the marking member based on the imaging feature to allow the aerial vehicle to land toward the marking member.

10. The method according to claim 9, wherein controlling the aerial vehicle to move away from the marking member includes:
controlling the aerial vehicle to move away from the marking member in a reference direction, the reference direction being opposite to a landing direction of the aerial vehicle.

11. The method according to claim 9, wherein controlling the aerial vehicle to move away from the marking member includes at least one of:
controlling the aerial vehicle to ascend in a vertical direction to cause the aerial vehicle to move away from the marking member in the vertical direction; or
reducing a speed of the aerial vehicle in a horizontal direction to form a speed difference between the aerial vehicle and the movable platform in the horizontal direction to allow the aerial vehicle to move away from the marking member in the horizontal direction.

12. The method according to claim 9, further comprising:
in a process of the aerial vehicle landing to the marking member of the movable platform, in response to detecting a moving status of the marking member not satisfying a preset moving condition, controlling the aerial vehicle to move away from the marking member.

13. The method according to claim 1, further comprising:
controlling the aerial vehicle to land toward a carrier surface of the movable platform, wherein before the aerial vehicle contacts the carrier surface of the movable platform, a thrust of the aerial vehicle is reduced to a preset thrust range, and/or a motor rotation speed of the aerial vehicle is reduced to a preset rotation speed range.

14. The method according to claim 13, further comprising:
estimating landing time of the aerial vehicle on the movable platform; and
estimating a relative displacement between the aerial vehicle and the movable platform in the moving direction of the movable platform in the estimated landing time.

15. The method according to claim 14, wherein a moving trajectory of the aerial vehicle includes a trajectory segment where a height of the aerial vehicle first decreases and then increases when the aerial vehicle lands to the marking member.

16. The method according to claim 15, wherein in the trajectory segment, a minimum height of a trajectory point of the aerial vehicle is lower than a height of the marking member.

17. The method according to claim 14, wherein when the aerial vehicle lands to the marking member, a moving trajectory of the aerial vehicle includes a first trajectory segment for height decrease, a second trajectory segment for height increase, and a third trajectory segment for height decrease in sequence, and the height decrease of the aerial vehicle in the first trajectory segment is greater than the height decrease of the aerial vehicle in the third trajectory segment.

18. An aerial vehicle control apparatus comprising:
one or more processors; and
one or more memories storing a program that, when executed by the one or more processors, causes the one or more processors to:
control an aerial vehicle to follow a movable platform to move based on an image of the movable platform collected by a visual sensor carried by the aerial vehicle;
in a process of following the movable platform to move, control the aerial vehicle to move to a right side of the movable platform in response to an obstacle existing on a left front side of a moving direction of the movable platform; and
in the process of following the movable platform to move, control the aerial vehicle to move to a left side of the movable platform in response to an obstacle existing on a right front side of the moving direction of the movable platform.

19. The aerial vehicle control apparatus according to claim 18, wherein the one or more processors are further configured to:
control the aerial vehicle to move to the right side of the movable platform in response to the obstacle existing on the left front side and located at an inner side of a turning direction of the movable platform.

20. The aerial vehicle control apparatus according to claim 18, wherein the one or more processors are further configured to:
control the acrial vehicle to move to the left side of the movable platform in response to the obstacle existing on the right front side and being located at an inner side of a turning direction of the movable platform.
